(19) United States
(12) Patent Application Publication
(10) Pub. No.: US 2026/0108326 A1
(43) Pub. Date: Apr. 23, 2026

(54) IMAGE-BASED TOOTH IDENTIFICATION USING DIGITAL DENTAL MODELS

(71) Applicant: Align Technology, Inc., San Jose, CA (US)

(72) Inventors: Yun Gao, Cary, NC (US); Guotu Li, Apex, NC (US); Christopher E. Cramer, Durham, NC (US); Chao Shi, Morrisville, NC (US); Chad Clayton Brown, Cary, NC (US); Niko Benjamin Huber, Zug (CH)

(21) Appl. No.: 19/365,036

(22) Filed: Oct. 21, 2025

Related U.S. Application Data
(60) Provisional application No. 63/710,226, filed on Oct. 22, 2024.

(51) Int. Cl. A61C 7/00; G06T 7/00

(52) U.S. Cl. CPC A61C 7/002; G06T 7/0014; G06T 2207/20076; G06T 2207/30036

(57) ABSTRACT

Systems and methods for identifying teeth in a patient image are provided. For example, a computer-implemented method can include, by one or more processors, accessing a 2D image including a depiction of a patient's teeth, where a plurality of the depicted patient's teeth are annotated with tooth identifiers according to a first tooth identification scheme. The computer-implemented method can further include transmitting, to a server computing device, the 2D image, and receiving from the server computing device, a second tooth identification scheme for the patient's teeth in the 2D image. The second tooth identification scheme can be generated by accessing a 3D model of the patient's teeth, projecting the 3D model onto the 2D image, comparing the projection to the 2D image to determine a probability parameter for each of one or more teeth in the 2D image, and determining, based on the probability parameters, the second tooth identification scheme.

### CROSS-REFERENCE TO RELATED APPLICATION(S)

The present application claims the benefit of priority to U.S. Provisional Application No. 63/710,226, filed Oct. 22, 2024, the disclosure of which is incorporated by reference herein in its entirety.

### TECHNICAL FIELD

The present technology generally relates to dentistry, and in particular, to systems and methods for image-based tooth identification using digital dental models.

### BACKGROUND

Telemedicine systems can improve the convenience and accessibility of dental treatment by allowing clinicians to monitor the condition of a patient's teeth remotely. For instance, a clinician may evaluate the teeth and make treatment decisions based on photographs of the teeth, rather than requiring an in-person appointment to visually examine the teeth. However, the reliability and quality of remote dental treatment may be compromised if the teeth cannot be accurately and consistently identified in the patient photographs. Conventionally, tooth identification can be performed manually by a human or automatically via image processing algorithms. Unfortunately, manual annotation can be time-consuming and prone to human error, and automated identification can be similarly resource-intensive and unreliable. For instance, both manual and automated annotation may result in mislabeled teeth, inconsistent labeling across time, and more. These errors can critically affect downstream treatment decisions, planning, and/or modeling of the teeth. Therefore, there is a need for improved tooth identification systems and methods.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a flow diagram illustrating a method for identifying teeth in a patient image, in accordance with embodiments of the present technology.

FIG. 2A illustrates a representative example of a 2D image depicting a patient's teeth, in accordance with embodiments of the present technology.

FIG. 2B illustrates a representative example of a 3D model of the patient's teeth of FIG. 2A, in accordance with embodiments of the present technology.

FIGS. 2C and 2D illustrate a first projection of the 3D model of FIG. 2B onto the 2D image of FIG. 2A, in accordance with embodiments of the present technology.

FIG. 2E illustrates a representative example of the 2D image of FIG. 2A with a corrected tooth identification scheme, in accordance with embodiments of the present technology.

FIG. 3 illustrates an example probability distribution of potential tooth identifiers for a tooth, in accordance with embodiments of the present technology.

FIGS. 4A and 4B illustrate an example location determination for a tooth, in accordance with embodiments of the present technology.

FIGS. 5A and 5B illustrate an example tooth contour determination, in accordance with embodiments of the present technology.

FIG. 6 is a flow diagram illustrating a method for identifying teeth in a patient image, in accordance with embodiments of the present technology.

FIG. 7 is a flow diagram illustrating a method for identifying teeth in a patient image, in accordance with embodiments of the present technology.

FIG. 8A illustrates a first 2D image of a patient's teeth, in accordance with embodiments of the present technology.

FIG. 8B illustrates a second 2D image of the patient's teeth, in accordance with embodiments of the present technology.

FIG. 9A illustrates a representative example of a tooth repositioning appliance configured in accordance with embodiments of the present technology.

FIG. 9B illustrates a tooth repositioning system including a plurality of appliances, in accordance with embodiments of the present technology.

FIG. 9C illustrates a method of orthodontic treatment using a plurality of appliances, in accordance with embodiments of the present technology.

FIG. 10 illustrates a method for designing an orthodontic appliance, in accordance with embodiments of the present technology.

FIG. 11 illustrates a method for digitally planning an orthodontic treatment and/or design or fabrication of an appliance, in accordance with embodiments of the present technology.

### DETAILED DESCRIPTION

The present technology relates to systems and methods for identifying a patient's teeth in images. In some embodiments, for example, a computer-implemented method for identifying teeth in a patient image includes accessing a two-dimensional (2D) image (e.g., a photograph) including a depiction of a patient's teeth, where a plurality of the depicted teeth are annotated with tooth identifiers (e.g., tooth numbers from a dental notation system) according to a first tooth identification scheme for the patient's teeth. For example, the first tooth identification scheme may have been generated via manual annotation or automated annotation by a software algorithm, and may include identification errors (e.g., mislabeled teeth). The method can further include accessing a three-dimensional (3D) model of the patient's teeth, such as a digital model generated as part of a treatment plan for the patient's teeth. The method can also include projecting a first projection of the 3D model onto the 2D image, based on the first tooth identification scheme. The method can further include comparing the first projection to the 2D image to determine a probability parameter (e.g., a numerical or other quantitative value, a qualitative value) for each of one or more teeth in the 2D image, where the probability parameter indicates a likelihood that a tooth identifier for the corresponding tooth in the 2D image is correct. For instance, the probability parameter can indicate whether one or more tooth identifiers in the first tooth identification scheme are erroneous and/or can indicate a correct tooth identifier for one or more teeth. The method can further include determining, based on the probability parameters for the one or more teeth, a second tooth identification scheme for the patient's teeth in the 2D image, where the second tooth identification scheme assigns a different tooth identifier to at least one of the patient's teeth depicted in the 2D image.

Alternatively, in some embodiments, a computer-implemented method includes accessing a 2D image including a depiction of a patient's teeth, which may be annotated with tooth identifiers having poor confidence scores or may not be annotated with tooth identifiers. The method can further include accessing a 3D model of the patient's teeth. The method can further include projecting a first projection of the 3D model onto the 2D image, where the first projection determines first tooth shapes (e.g., contours) for the patient's teeth. The method can further include determining second tooth shapes for the patient's teeth depicted in the 2D image. The method can further include comparing one or more of the first tooth shapes of the first projection to one or more corresponding second tooth shapes of the 2D image to determine a probability parameter (e.g., a numerical or other quantitative value, a qualitative value) for each of one or more teeth in the 2D image, where the probability parameter indicates a likelihood that a tooth identifier for the corresponding tooth in the 2D image is correct. The method can further include determining, based on the probability parameters for the one or more teeth, a tooth identification scheme for the patient's teeth in the 2D image.

The present technology can provide various advantages compared to conventional techniques for tooth identification. For example, some conventional techniques involve manually assigning a tooth identifier for each tooth. This can be time-consuming, labor-intensive, and prone to human error. Other techniques may involve the utilization of machine learning algorithms for automatically assigning tooth identifiers. However, these algorithms may not be perfect or even acceptable—e.g., they may suffer from poor training data, be inflexible, generate incorrect identifications, and/or fail altogether. Moreover, the nature of the aforementioned techniques may require the direct involvement of a dental practitioner (e.g., via clinical visits for dental imaging and/or manual tooth identification) and/or a high-performance computing machine (e.g., for image processing and segmentation), which may not be accessible for all patients. Further, conventional techniques may lack validation capabilities, such that an initial guess for a tooth identifier is assumed to be correct without additional review. This may result in treatment decisions based on incorrect information, which may ultimately result in complications or suboptimal treatment outcomes for the patient.

The present technology can address these and other challenges by providing automated tooth identification and validation. For instance, some embodiments of the present technology may generate tooth identification schemes for a patient's teeth using images taken with a smartphone or other device readily accessible to the patient. Further, some embodiments of the present technology may leverage both 2D images and 3D models of the patient's teeth to improve tooth identification accuracy and efficiency. For example, the combined usage of 2D images and 3D models of the patient's teeth may provide for informed comparison and probability calculations that reflect the likelihood that a given tooth identification scheme is correct, and the tooth identification scheme may be modified until it is satisfactory.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Image-Based Tooth Identification

The present technology provides systems and methods for determining and/or correcting a tooth identification scheme in an image of a patient's teeth. A tooth identification scheme can, for example, include annotations conveying the identity of one or more of the patient's teeth. For instance, the tooth identification scheme may include tooth identifiers in the form of numbers (e.g., 1, 2, 3, etc.), letters, symbols (e.g., +, −, *, etc.), descriptors (e.g., “canine,” “molar,” “incisor,” etc.), colors (e.g., red, green, blue, etc.), patterns (e.g., striped, dotted, etc.), and/or any other suitable notations. Many notation systems can be used, such as the universal numbering system, Palmer notation, and/or the FDI World Dental Federation notation. Additionally or alternatively, a dental practitioner may have preferred and/or unique notation systems for their patients. Regardless of the desired notation system, tooth identifiers can relay relevant information regarding a given tooth's shape, position, condition, etc.

In some situations, it may be desirable to provide dental treatment based on images of the patient's teeth rather than an in-person visual examination of the teeth, such as when a virtual dental care system is used (e.g., as described in U.S. Patent Application Publication No. 2022/0023003, the disclosure of which is incorporated by reference herein in its entirety). This can improve accessibility to care and reduce time and costs associated with clinical visits. Further, self-captured images can allow a dental practitioner to have more frequent check-ins on a patient's progress, e.g., over the course of the dental treatment.

Once an image is captured, whether in the clinic or at home, identifying teeth in the image can be a significant step in patient monitoring, treatment planning, and/or the construction of dental models. A correct tooth identification scheme can allow a dental practitioner to reliably assess a patient's dental condition and design a suitable treatment plan. In contrast, an incorrect tooth identification scheme may lead to a misdiagnosis, and possibly ineffective and/or adverse treatment outcomes, such as the wrong tooth being repositioned. Further, in constructing artificial intelligence (AI) models based on labeled dental images, correct tooth identification schemes can lead to robust training data and improve model fidelity. On the other hand, incorrect tooth identification schemes can cause a dental AI model to learn incorrect relationships in the dental data (e.g., due to missing tooth identifiers, mismatched tooth identifiers, class imbalance, etc.).

Unfortunately, incorrect tooth identification occurs more frequently than desired in conventional image-based tooth identification processes. In such processes, teeth are typically identified via manual or automated assessment. In manual assessment, a patient's image is reviewed by a human evaluator who may directly annotate or otherwise assign tooth identifiers to the patient's teeth based on their personal experience and/or estimations. This can be prone to human error and inconsistencies across images and/or patients, especially when considering a large set of images that may be taken throughout the course of a dental treatment or as may be required for training a dental AI model. In automated assessment, software algorithms are used to predict tooth identifiers from the patient's image, but predicted tooth identifiers may be incorrect based on false algorithm assumptions and/or errors. Moreover, in some situations, it may be difficult to detect such issues since the internal algorithm parameters used to produce the tooth identifiers may not be interpretable and/or known.

In some situations, an incorrect tooth identification scheme includes at least one tooth identifier that is inconsistent with (e.g., incorrect in view of) a selected notation system (e.g., the universal numbering system). As an example, a patient's image may depict a right permanent maxillary canine annotated with tooth #12, whereas conventional practice may suggest that the right permanent maxillary canine should be annotated with the tooth #6. As another example, the patient's teeth may have shifted labels. For instance, the patient's right permanent maxillary canine may be incorrectly annotated with the tooth #7, and a tooth adjacent to the right permanent maxillary canine may be incorrectly annotated with the tooth #6. Other errors may include missing labels, labels that span multiple teeth, and/or inconsistencies across images of the same patient.

The present technology addresses these and other concerns by providing an improved automated determination and/or validation of tooth identifiers for a patient's teeth. In some embodiments, 3D models of the patient's teeth are used in combination with 2D images of the patient's teeth to improve tooth identification and correct errors. The use of the 3D models may leverage prior information relevant to the tooth identifiers and allow for more streamlined and/or more accurate tooth identification. Further, some embodiments of the present technology are iterative, such that tooth identifiers are determined and corrected until satisfactory.

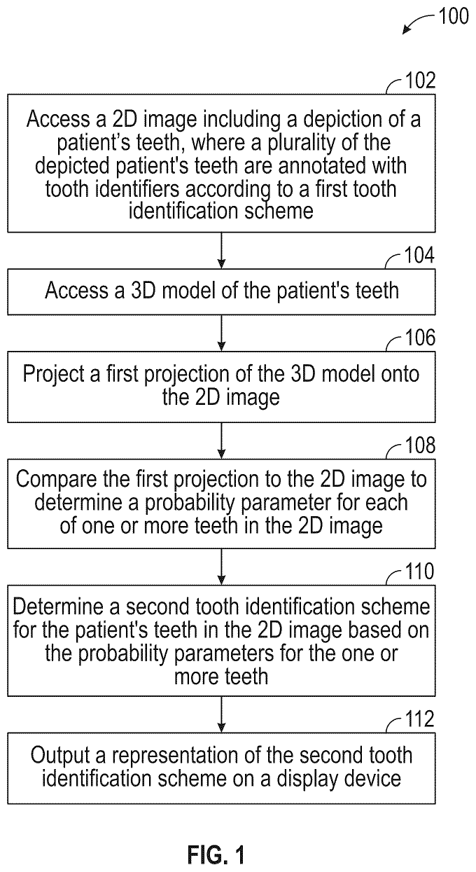

FIG. 1 is a flow diagram illustrating a method 100 for identifying teeth in a patient image, in accordance with embodiments of the present technology. The method 100 can be used to detect and correct incorrectly annotated teeth associated with a two-dimensional (2D) image of a patient's teeth. In some embodiments, some or all of the processes of the method 100 are implemented as computer-readable instructions (e.g., program code) that are configured to be executed by one or more processors of a computing device (e.g., a mobile device, laptop, personal computer, workstation, remote server). In some embodiments, the computing device is part of a virtual dental care system as described in, e.g., U.S. Patent Application Publication No. 2022/0023003, the disclosure of which is incorporated by reference herein in its entirety.

The method 100 can begin at block 102 with accessing a 2D image including a depiction of a patient's teeth. The 2D image can include any suitable image data type, such as one or more photographs, one or more frames of a video, etc. The 2D image can depict the patient from any suitable view, such as a front view of the patient's head while smiling, a close-up view of the patient's upper jaw, a close-up view of the patient's lower jaw, buccal views with the jaw open, buccal views with the jaw closed, occlusal views, lingual views, etc. The appropriate view may be determined based on the particular dental condition or treatment of interest, e.g., an upper occlusal view may be relevant for a patient who is undergoing or is being evaluated for palatal expansion therapy. In some situations, only some of the patient's teeth are depicted in the 2D image. For example, some of the patient's teeth may be covered by the patient's lips, dental appliances, and/or other objects.

The 2D image can be obtained using any suitable imaging device, such as a digital camera (e.g., a DSLR camera, a mirrorless camera). Optionally, the imaging device can be part of or can be operably coupled to a computing device (e.g., a mobile device such as a smartphone or tablet; a desktop device; a server). The computing device may be operated by or associated with the patient, a healthcare provider (e.g., a clinician), or other suitable user. Alternatively or in combination, the 2D image can be derived from scan data (e.g., intraoral and/or extraoral scans), magnetic resonance imaging (MRI) data, and/or radiographic data (e.g., standard x-ray data such as bitewing x-ray data, panoramic x-ray data, cephalometric x-ray data, computed tomography (CT) data, cone-beam computed tomography (CBCT) data, fluoroscopy data).

In some embodiments, the 2D image is obtained using the imaging device only, without assistance from any auxiliary devices. In other embodiments, however, the 2D image can be obtained using the imaging device in combination with an auxiliary device to position the imaging device in a fixed spatial location with respect to the patient's teeth and/or to retract the patient's cheeks and lips to improve visibility of the teeth. For example, the auxiliary device can include one or more cheek retractors. As another example, the auxiliary device can be a tube-type device including a smartphone interface configured to couple to a smartphone (or other mobile device with a camera), a patient interface configured to retract the patient's cheeks and lips, and a tubular body between the smartphone interface and the patient interface with a lumen extending therethrough, e.g., as described in U.S. Patent Application Publication No. 2022/0338723, the disclosure of which is incorporated by reference herein in its entirety. Other representative examples of systems, methods, and devices for obtaining 2D images of a patient are provided in U.S. Patent Application Publication No. 2022/0023003, the disclosure of which is incorporated by reference herein in its entirety. In some embodiments, the obtained images may be transmitted to a remote server or some other computing system (e.g., on a local network) for performing some or all of the subsequent steps.

In some embodiments, the 2D image is accessed from a database, such as an image repository. The image repository can be part of a local computing system, such as a dental treatment system or a machine learning system. Optionally, the 2D image may be stored on a mobile device, such as a smartphone. Alternatively or additionally, the 2D image may be stored on a remote server.

In some embodiments, at least some or all of a plurality of the depicted patient's teeth in the 2D image are annotated with tooth identifiers according to a first tooth identification scheme. The tooth identifiers can be or include numbers, letters, symbols, categorical labels, and/or other identifiers or descriptors. For instance, each of the annotated teeth can have a respective numerical identifier. The numerical identifiers may be selected from a dental notation system, such as the universal numbering system which ranges from #1 to #32. Alternatively, the numerical identifiers may be in accordance with any numbering system, such as a custom numbering system predetermined by a dental practitioner, or a numbering system in conformance with a dental condition. In some embodiments, the tooth identifiers are visually depicted in the 2D image, e.g., as a graphical overlay. Alternatively or in combination, the tooth identifiers may be stored as metadata associated with the 2D image. For example, the metadata can include regions (e.g., a set of image pixels) in the 2D image corresponding to the patient's teeth and a tooth identifier for each region.

The 2D image can already be annotated with the first tooth identification scheme, or the first tooth identification scheme can be generated as part of the method 100 (e.g., as part of the process of block 102). In some embodiments, the first tooth identification scheme is generated by manual annotation. For instance, a human user may view the 2D image depicting the patient's teeth and may individually assign tooth identifiers to some or all of the patient's teeth. Alternatively, the first tooth identification scheme may be automatically generated. For instance, the first tooth identification scheme can be generated by a software algorithm that analyzes the 2D image to identify individual teeth in the image and assigns an appropriate tooth identifier to each tooth. In some embodiments, multiple software algorithms may be used, such as a tooth segmentation model to segment individual teeth from the 2D image and a tooth identification model to assign tooth identifiers to the individual teeth. Tooth segmentation and identification may be performed, for example, using a machine learning model (e.g., a neural network) that has been trained on labeled images of teeth. In some embodiments, the machine learning model uses semantic segmentation techniques, e.g., as described in U.S. Patent Application Publication Nos. 2022/0023003 and 2023/0225831, the disclosures of which are incorporated by reference herein in their entirety. Other types of segmentation techniques that may alternatively or additionally be used include, for example, object segmentation, instance segmentation, and panoptic segmentation. Optionally, the 2D image may be annotated with the first tooth identification scheme using a combination of manual and automated annotation techniques, e.g., a software algorithm may generate an initial set of annotations that are reviewed by a human user.

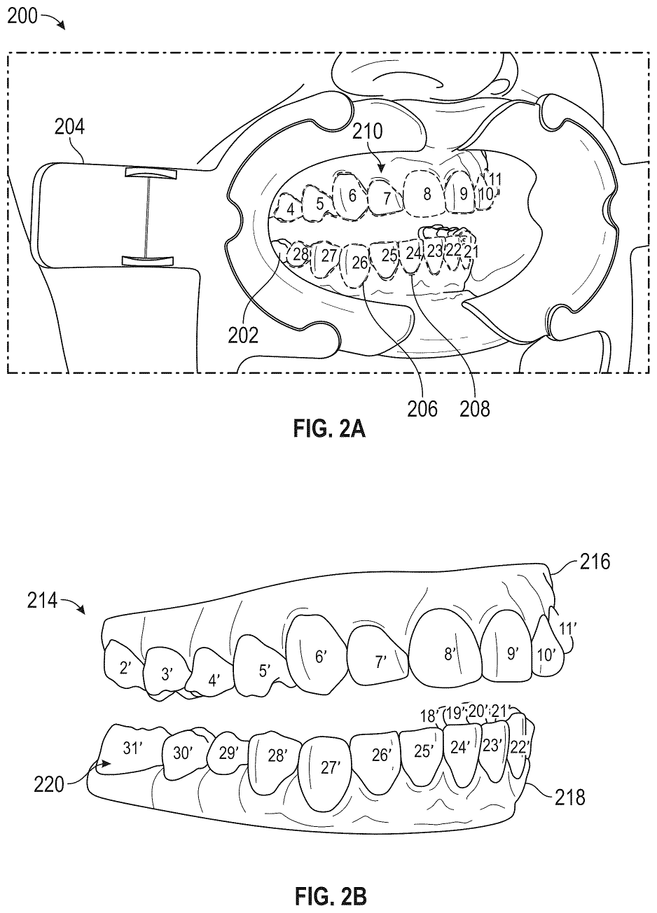

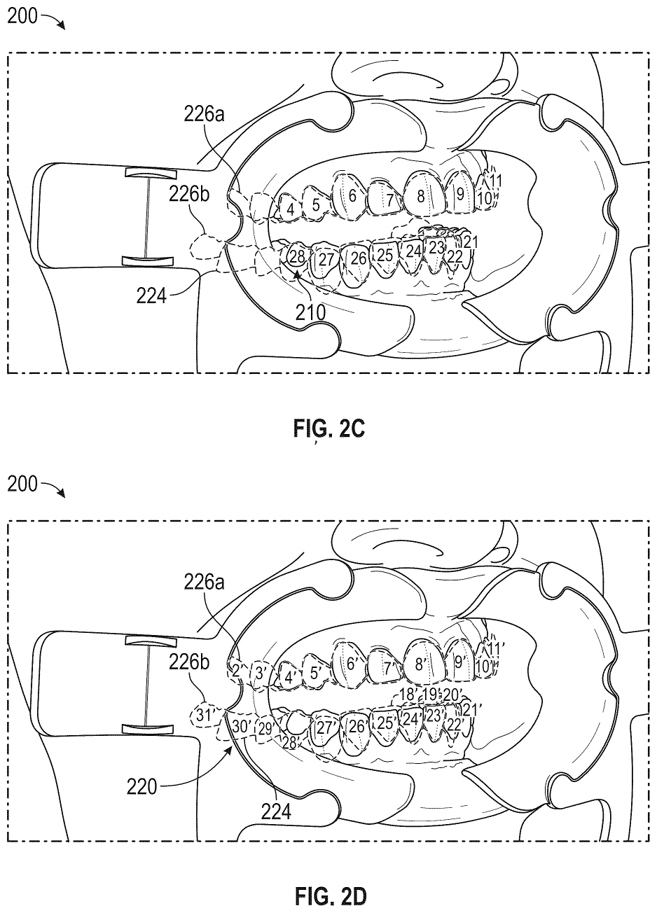

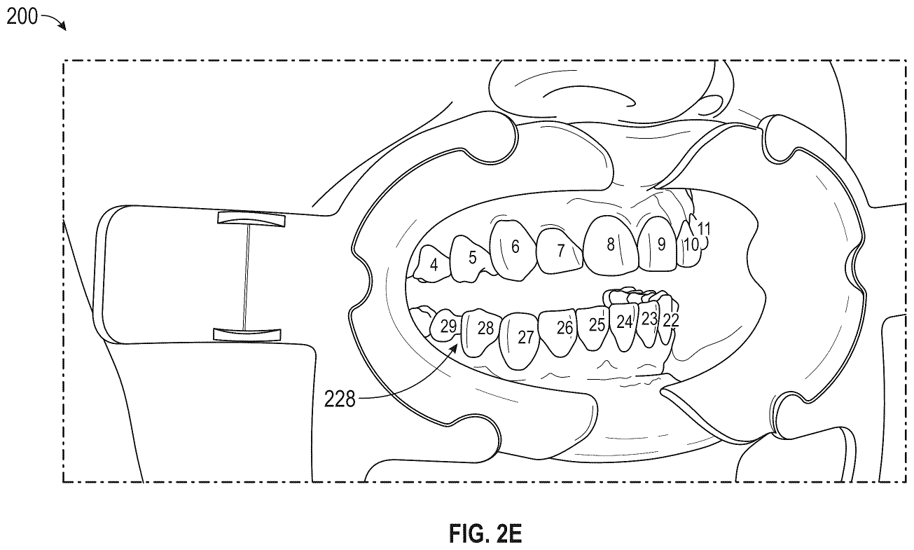

FIG. 2A illustrates a representative example of a 2D image 200 depicting a patient's teeth 202, in accordance with embodiments of the present technology. In the illustrated embodiment, the 2D image 200 includes a right buccal view of the patient's face with visibility of at least a portion of the patient's teeth 202. For instance, the patient's face may be depicted with jaws open. An auxiliary device 204 is also depicted, such as a set of cheek retractors configured to retract the patient's cheeks and lips to improve visibility of the patient's teeth 202. In some cases, a dental appliance may also be depicted in the 2D image 200, such as a dental aligner positioned on the patient's teeth 202.

In some embodiments, the 2D image 200 is segmented into a plurality of regions corresponding to individual teeth, such that a tooth segmentation mask 206 (shown as dashed lines) encompassing the segmented teeth regions can be defined with respect to the 2D image 200. The tooth segmentation mask 206 can include a series of contour lines 208 representing tooth boundaries for the individual teeth. Alternatively or in combination, the tooth segmentation mask 206 can include areas representing tooth geometries for each tooth, such as the regions enclosed by the contour lines 208. The tooth segmentation mask 206 may be generated by a segmentation algorithm, manual segmentation, and/or a combination thereof. In some embodiments, the tooth segmentation mask 206 is depicted in the 2D image 200, e.g., as an overlay on the patient's teeth 202. Additionally or alternatively, the tooth segmentation mask 206 can be depicted in another image separate from the 2D image 200, and/or the tooth segmentation mask 206 may be included in metadata associated with the 2D image 200.

In some embodiments, the 2D image 200 is annotated with a first tooth identification scheme 210 including a plurality of tooth identifiers corresponding to individual teeth (e.g., referencing FIG. 2A, numbers #4-#11 corresponding to teeth of the upper jaw visible in the image and numbers #21-#28 corresponding to teeth of the lower jaw visible in the image). The tooth identifiers can be or include annotations of any suitable label and/or descriptor that are generated via manual and/or automated processes, as described elsewhere herein. For instance, the tooth identifiers can include a numerical identifier for each of the annotated teeth of the patient's teeth 202, as shown. However, the tooth identifiers may alternatively or additionally include other annotations such as letters, symbols, descriptors, patterns, gradients, etc. The first tooth identification scheme 210 can be part of the tooth segmentation mask 206, or can be separate from the tooth segmentation mask 206. In some embodiments, the tooth segmentation mask 206 is used to determine the first tooth identification scheme 210, e.g., the tooth identifiers of the first tooth identification scheme 210 can be assigned based on the shapes and/or locations of the individual tooth regions of the tooth segmentation mask 206.

While FIG. 2A depicts the tooth identifiers as being visible in the 2D image 200 (e.g., superimposed on the corresponding patient's teeth 202), in some embodiments, the tooth identifiers are not depicted in the 2D image 200. For instance, the tooth identification scheme 210 including the tooth identifiers can be stored in metadata associated with the 2D image 200. As an example, the metadata may include information defining regions (e.g., a set of image pixels) in the 2D image 200 corresponding to the patient's teeth 202, and each of the regions may be associated with a tooth identifier. Optionally, the regions may be determined based on the tooth segmentation mask 206 (e.g., the regions may be the same as the tooth regions defined by the tooth segmentation mask 206). Further, the metadata may be accessed separately from the 2D image 200 or together with the 2D image 200.

As depicted in FIG. 2A, the first tooth identification scheme 210 may be incorrect. For instance, one or more of the tooth identifiers may have an incorrect annotation. In the illustrated example (as will be made clear in the discussion associated with FIGS. 2C and 2D), the tooth identifiers of each of the teeth 202 in the patient's lower jaw is incorrect by one numeral (e.g., offset by one), e.g., tooth #25 should actually be tooth #26, tooth #26 should actually be tooth #27, etc. Other errors that may occur include omitted annotations (e.g., missing tooth identifiers in one or more teeth), overlapping annotations (e.g., a tooth identifier spans multiple teeth), shared annotations (e.g., multiple teeth have the same tooth identifier), etc. Such errors may be attributable to human error in manual annotation, software errors for automated annotation, etc.

Referring again to FIG. 1, at block 104, the method 100 can continue with accessing a 3D model of the patient's teeth. The 3D model can depict the 3D geometry of the patient's teeth and/or any other dental features of interest (e.g., intraoral anatomy, dental appliances, etc.). In some embodiments, the 3D model depicts the patient's teeth in a current tooth arrangement, e.g., a tooth arrangement at the same time or substantially the same time as when the 2D image of the patient's teeth was obtained. In some embodiments, the 3D model depicts the patient's teeth in a previous tooth arrangement, e.g., a tooth arrangement before the 2D image of the patient's teeth was obtained. In some embodiments, the 3D model depicts the patient's teeth in a tooth arrangement specified by a treatment plan for the patient's teeth. For instance, the 2D image can be obtained during a treatment stage of the treatment plan, and the tooth arrangement depicted in the 3D model is a tooth arrangement for the current treatment stage, a previous treatment stage, or a planned future treatment stage. The tooth arrangement can be an initial tooth arrangement corresponding to an initial treatment stage (e.g., before any dental appliances have been worn on the teeth), an intermediate tooth arrangement corresponding to an intermediate treatment stage (e.g., after one or more dental appliances have been worn on the teeth), or a target tooth arrangement corresponding to a final or post-treatment stage (e.g., after tooth repositioning is complete).

In some embodiments, the 3D model is accessed from a database, such as a model repository, a treatment planning datastore, etc. The database can be part of a local computing system, such as a dental treatment system or a machine learning system. Optionally, the 3D model may be stored on a mobile device, such as a smartphone. Alternatively or additionally, the 3D model can be accessed over a network (e.g., from a remote server).

The 3D model can be generated based on data of the patient's teeth, such as from photographs and/or videos (as captured on, e.g., a mobile computing device such as a smartphone, or another suitable device with a camera), scan data (e.g., intraoral and/or extraoral scans), magnetic resonance imaging (MRI) data, and/or radiographic data (e.g., standard x-ray data such as bitewing x-ray data, panoramic x-ray data, cephalometric x-ray data, computed tomography (CT) data, cone-beam computed tomography (CBCT) data, fluoroscopy data). In some embodiments, for example, the 3D model of the tooth arrangement is based on scan data obtained using an intraoral scanner. The scanner can include a probe (e.g., a handheld probe) for optically capturing 3D structures (e.g., by confocal focusing of an array of light beams). Examples of scanners include, but are not limited to, the iTero® intraoral digital scanner manufactured by Align Technology, Inc. In some embodiments, the data of the patient's teeth is used to generate a first 3D model depicting a current and/or pre-treatment arrangement of the teeth, and the first 3D model is then used to generate one or more additional 3D models depicting the teeth in one or more planned tooth arrangements of a dental treatment plan. The 3D model may be any suitable digital representation that shows the 3D geometry of the teeth, such as a surface or mesh model, a solid model, a point cloud, a plurality of stacked 2D images, etc.

In some embodiments, the 3D model can be generated prior to the capture of the 2D image. For instance, the 3D model may be generated during a previous dental appointment, e.g., an initial appointment prior to starting dental treatment or a routine dental appointment. Alternatively, the 2D image can be captured prior to the generation of the 3D model, or the 2D image and the 3D model can be captured and generated concurrently.

In some embodiments, the 3D model is annotated with a respective tooth identification scheme, also referred to herein as a “model tooth identification scheme.” The model tooth identification scheme can provide tooth identifiers for some or all of the teeth of the 3D model. For example, tooth identifiers can be assigned to the teeth of the 3D model, e.g., via manual annotation, automated annotation, or suitable combinations thereof. The 3D model can already be annotated with the model tooth identification scheme, or the model tooth identification scheme can be generated as part of the method 100 (e.g., as part of the process of block 104). In some situations, the confidence level of the model tooth identification scheme may be higher than the confidence level of the first tooth identification scheme of the 2D image, e.g., since the depiction of the teeth in the 3D model may be more complete than the depiction of the teeth in the 2D image and thus the teeth in the 3D model may be identified more reliably. The model tooth identification scheme may be used in subsequent registration processes, as described further below.

FIG. 2B illustrates a representative example of a 3D model 214 of the patient's teeth 202 of FIG. 2A, in accordance with embodiments of the present technology. As shown, the 3D model 214 can include a first model portion 216 representing an upper jaw of the patient and a second model portion 218 representing a lower jaw of the patient. However, the 3D model 214 can alternatively omit either of the first model portion 216 or the second model portion 218. In some embodiments, the 3D model 214 further includes digital representations of other intraoral objects, such as other intraoral tissue (e.g., gingiva, palate), a dental appliance, dental auxiliaries on the teeth 202, etc. In some embodiments, as depicted, the 3D model 214 can be associated with a model tooth identification scheme 220. The model tooth identification scheme 220 may include model tooth identifiers (the model tooth identifiers are shown as #2′, #3′, #4′, etc., to distinguish them from the tooth identifiers of the 2D image 200 of FIG. 2A). The model tooth identifiers may depict tooth identifiers with a greater confidence level than the tooth identifiers of the 2D image 200 of FIG. 2A. For instance, the model tooth identifiers may represent the correct and/or objective tooth identifiers for the patient's teeth.

Referring again to FIG. 1, at block 106, the method 100 can include projecting a first projection of the 3D model onto the 2D image. In some embodiments, the first projection is used to compare features of the 3D model with features of the 2D image for purposes of determining whether the first tooth identification scheme is correct, as described further below. The projection process can be performed in many different ways. In some embodiments, the 3D model is registered to the 2D image to determine a spatial mapping between the 3D reference frame (e.g., 3D coordinate space) of the 3D model and the 2D reference frame (e.g., 2D coordinate space) of the 2D image, and the spatial mapping is used to project the 3D model into the 2D reference frame of the 2D image. The registration can be performed, for example, by matching one or more teeth in the 3D model to one or more teeth in the 2D image, e.g., based on tooth identifiers, edges, shapes, location, etc. Alternatively or in combination, the registration can involve projecting the 3D model into the 2D reference frame, e.g., based on knowledge of the imaging parameters for the 2D image (e.g., focal length, aperture, position and/or orientation of the imaging device used to obtain the 2D image), and/or by projecting the 3D model according to a plurality of different simulated imaging parameters and selecting the set of imaging parameters that produce the greatest similarity between the projected 3D model and the 2D image. For instance, the 3D model may be registered to the 2D image by iteratively projecting the 3D model onto the 2D image and adjusting virtual camera parameters until the registration is satisfactory. Any suitable 3D to 2D registration algorithm can be used, for example, as described in U.S. Pat. Nos. 11,20,205 and 11,723,748, which are incorporated by reference herein in their entirety. Alternatively or additionally, any other suitable methods may be used, e.g., a Ceres Solver and an optimization algorithm (e.g., a trust region optimization algorithm such as a Dogleg or Levenberg-Marquardt algorithm; a line search optimization algorithm such as Dense QR, Dense Normal Cholesky, Sparse Normal Cholesky, CGNR, Schur algorithm-based approaches; etc.).

In some embodiments, the projection of the first projection of the 3D model onto the 2D image is based on the first tooth numbering scheme of the 2D image. For instance, an initial estimate of virtual camera parameters for the first projection in the 3D to 2D registration algorithm can be based on the first tooth numbering scheme, e.g., the initial estimate of the parameters for the registration can be based on the assumption that the first tooth numbering scheme is correct. That is, in these embodiments, virtual camera parameters (e.g., position, orientation, etc., of a virtual camera that is “capturing” a view of the 3D model) may be determined based on the first numbering scheme to generate a first projection of the 3D model, and this may be projected onto the 2D image. The first tooth numbering scheme can be provided as input to the registration algorithm, e.g., as part of a tooth segmentation mask generated from the 2D image. In embodiments where the 3D model is annotated with a model tooth identification scheme, the registration can be also based on the model tooth identification scheme of the 3D model, e.g., the initial estimate for the registration algorithm can be produced by matching one or more teeth in the 3D model to one or more teeth in the 2D image based on their respective tooth identifiers, with the assumption that the tooth identifiers are assigned correctly in both identification schemes. Thus, significant registration errors (corresponding to a low registration score) may be indicative of inaccuracies in the first tooth numbering scheme of the 2D image, as discussed further below.

In embodiments where the 2D image and the 3D model both depict a patient's upper and lower jaws, the upper and lower jaws can be registered in a joint-jaw registration. Specifically, a joint-jaw registration algorithm can be used to determine estimates for camera parameters as well as the spatial relationships between the upper and lower jaws, such that the projection of the patient's upper and lower jaws under the estimated camera parameters aligns closely with the depiction of the upper and lower jaws in the 2D image. For instance, where the 2D image depicts the patient's upper and lower jaws in a bite-open configuration (e.g., the upper and lower jaws are separated), the joint-jaw registration algorithm can match the upper and lower jaws in the 3D model to the upper and lower jaws in the 2D image, e.g., by adjusting the degree of separation between the jaws in the 3D model. Further, where the 2D image depicts the patient's upper and lower jaws in a bite-closed configuration, the joint-jaw registration can estimate where the lower jaw would sit with respect to the upper jaw based on a lower jaw articulator model. The lower jaw articulator model may, for example, define the range of articulation of the lower jaw relative to the upper jaw. This may be useful, for example, in constraining the possible range of spatial relationships between the upper and lower jaws for the registration process. Moreover, the joint-jaw registration may provide additional cross-jaw references (e.g., relationships between the upper and lower teeth of the patient's teeth) for tooth identification, which may improve accuracy. Representative examples of joint-jaw registration techniques that are applicable to the present technology are provided in U.S. patent application Ser. No. 18/898,623, the disclosure of which is incorporated by reference herein in its entirety.

FIGS. 2C and 2D illustrate a first projection 224 of the 3D model 214 of FIG. 2B projected onto the 2D image 200 of FIG. 2A, in accordance with embodiments of the present technology. Referring to FIGS. 2C and 2D together, the first projection 224 (shown as dashed lines) can depict the projected shapes and locations of the patient's teeth as represented in the 3D model 214 under the camera parameters produced by the registration algorithm. Stated differently, a 2D representation of the 3D model 214 can be superimposed onto the 2D image 200, where the 2D representation depicts a view of the 3D model 214 using the camera parameters from the registration algorithm. The camera parameters for the first projection 224 (e.g., camera location, pose) can be the same or similar as the camera parameters of the imaging device used to obtain the 2D image 200.

As previously described, the registration between the 3D model 214 and the 2D image 200 used to generate the first projection 224 can be based on the first tooth identification scheme 210. In some embodiments, for example, the tooth identifiers of the first tooth identification scheme 210 (shown in FIG. 2C) and the model tooth identifiers (shown in FIG. 2D) of the model tooth identification scheme 220 are used to match one or more teeth of the 3D model 214 and the 2D image 200 to each other during the registration process. Accordingly, if the first tooth identification scheme 210 is incorrect, there may be significant registration errors resulting in a low registration score. For instance, if the shapes and locations of the patient's teeth in the first projection 224 differ significantly from the shapes and locations of the patient's teeth in the 2D image 200 (e.g., as defined by the tooth segmentation mask 206), this may indicate that the first tooth identification scheme 210 is inaccurate. Conversely, if the registration score is high, e.g., if the shapes and locations of the patient's teeth in the first projection 224 are substantially similar to the shapes and locations of the patient's teeth in the 2D image 200 (e.g., as defined by the tooth segmentation mask 206), this may indicate that the first tooth identification scheme 210 is accurate.

In the example shown in FIGS. 2C and 2D, the first projection 224 does not align well with the patient's teeth 202 in the 2D image 200 (e.g., corresponding to the tooth segmentation mask 206, which is omitted in FIGS. 2C and 2D merely for purposes of simplicity). The first projection 224 includes an upper projection region 226a corresponding to the upper teeth of the 3D model 214 and a lower projection region 226b corresponding to the lower teeth of the 3D model 214. The shapes and locations of the teeth in the upper projection region 226a are well aligned with the shapes and locations of the upper teeth in the 2D image 200 (indicating that the tooth identifiers of the upper teeth were likely correctly determined in the first tooth identification scheme 210), but the shapes and locations of the teeth in the lower projection region 226b are poorly aligned with the shapes and locations of the lower teeth in the 2D image 200 (indicating the tooth identifiers of the lower teeth were likely incorrectly determined in the first tooth identification scheme 210). For instance, the registration process has attempted to match tooth #28 of the lower projection region 226b (FIG. 2D) to tooth #28 of the 2D image 200 (FIG. 2C), but the registration outcome (e.g., score) is poor, e.g., there are significant discrepancies between the shape and location of model tooth #28 in the lower projection region 226b versus the corresponding tooth of the 2D image 200. Thus, the first tooth identification scheme 210 is likely to be inaccurate for the lower teeth but accurate for the upper teeth.

At block 108, the method 100 can include comparing the first projection to the 2D image to determine a probability parameter for each of one or more teeth in the 2D image. The probability parameter can indicate a likelihood that a tooth identifier for the corresponding tooth in the 2D image is correct. For example, the probability parameter can indicate whether a tooth identifier provided by the first tooth identification scheme is likely to be correct or incorrect (e.g., the first tooth identification scheme assigned #25 to tooth X, but there is only a 25% likelihood that this identification is accurate). Alternatively or in combination, the probability parameter can indicate whether a tooth identifier different from the tooth identifier provided by the first tooth identification scheme is likely to be correct or incorrect (e.g., there is an 80% likelihood that tooth X is #26). In some embodiments, the probability parameter can provide a plurality of sub-parameters for an individual tooth, where the plurality of sub-parameters each represent the respective likelihoods for a plurality of different potential tooth identifiers for the tooth (e.g., there is a 50% likelihood that tooth X is #24, a 30% likelihood that tooth X is #25, a 20% likelihood that tooth X is #26, a 0% likelihood that tooth X is #27, etc.). This may be represented as a probability matrix or distribution, with each tooth in an image being associated with a plurality of sub-parameters (e.g., probabilities for each possible tooth number). Optionally, a plurality of sub-parameters may be represented as a histogram (or other graphical representation) that depicts a plurality of potential tooth identifiers for a particular tooth (e.g., on the x-axis) and a respective probability for each potential tooth identifier (e.g., on the y-axis). A histogram may be generated for each tooth, and a maximum likelihood algorithm may be used to select tooth identifiers from the set of histograms across all teeth, based on posterior probabilities and tooth identifier constraints, e.g., as discussed in greater detail below. In some embodiments, a probability parameter can be determined for each tooth of the patient's teeth in the 2D image. Alternatively, a probability parameter may be determined for only a subset of the patient's teeth in the 2D image (e.g., only teeth that are clinically relevant for diagnosis and/or treatment, only teeth are sufficiently visible, only teeth near the center of the image).

In some embodiments, the probability parameter is a quantitative parameter, such as a number, percentage, score, etc. For instance, a projection with a high similarity between the projected 3D model and the 2D image may have a high registration score, whereas a projection with a low similarity between the projected 3D model and the 2D image may have a low registration score. The probability parameter may be a numeric value within a range from 0 to 1, where 0 is 0% likelihood that the tooth identifier for the corresponding tooth in the 2D image is correct, and 1 is a 100% likelihood that the tooth identifier for the corresponding tooth in the 2D image is correct. Many suitable ranges may be used to capture the variation in probability parameters. For example, the probability parameter may be within a range from 0 to 10, 0 to 20, 0 to 50, 0 to 100, etc. In some embodiments, the probability parameter is a qualitative parameter, such as a rating, categorization, etc. For instance, the probability parameter for the tooth identifier can be “very unlikely,” “unlikely,” “questionable,” “likely,” “very likely,” etc.

In some embodiments, the process of block 108 further produces a global probability parameter. The global probability parameter may represent the overall likelihood that the first tooth identification scheme across all of the patient's teeth is correct. The global probability parameter may be generated based on corresponding probability parameters for each of the one or more teeth in the 2D image, or may be generated separately from the corresponding probability parameters. For instance, in some embodiments, the global probability parameter is an average of the corresponding probability parameters.

The probability parameters for the patient's teeth can be determined by comparing the first projection of the 3D model with the 2D image (e.g., with a tooth segmentation mask of the 2D image). Specifically, since the 3D model is projected onto the 2D image based on the first tooth identification scheme, significant deviations between the first projection of the 3D model and the 2D image can indicate that the first tooth identification scheme is inaccurate, e.g., one or more tooth identifiers in the first tooth identification scheme are incorrect.

For example, referring again to FIGS. 2C and 2D, the tooth labeled #28 in the 2D image 200 (FIG. 2C) is poorly aligned with tooth #28′ of the first projection 224 (FIG. 2D). Thus, there is a low likelihood that #28 is the correct tooth identifier for this tooth in the 2D image 200. In contrast, the tooth labeled #7 in the 2D image 200 (FIG. 2C) is well aligned with tooth #7′ of the first projection (FIG. 2D). Thus, there is a high likelihood that #7 is the correct identifier for this tooth in the 2D image 200.

Referring again to block 108 of FIG. 1, the comparison between the first projection of the 3D model and the 2D image can be performed in many different ways. In some embodiments, a registration score between the first projection and the 2D image is determined, where a low registration score is indicative of significant deviations between the first projection and the 2D image. The registration score can be determined in various ways, such as based on a degree of similarity between the first projection and the 2D image. In some embodiments, the degree of similarity is evaluated based on an amount of overlap and/or intersection between the first projection and the 2D image, such as a computed intersection over union (IoU). The IoU may be computed by dividing the area of intersection (e.g., overlap) between teeth in the first projection and teeth in the 2D image by the overall area covered by both the teeth in the first projection and the teeth in the 2D image. IoU can be computed for the upper jaw, lower jaw, upper and lower jaws, on a per-tooth basis, and/or on a regional basis. Further, a mean IoU (mIoU) can be computed by taking the average IoU across all of the patient's teeth (or a suitable subset thereof). In some embodiments, a high IoU (e.g., greater than 0.5, such as greater than 0.8) corresponds to a high registration score, whereas a low IoU (e.g., less than 0.5, such as less than 0.2) corresponds to a low registration score. One or more threshold values may be predetermined or dynamically determined for classifying a registration score (e.g., a score below a low threshold may be a low score, a score between the low threshold and a high threshold may be a medium score, and a score greater than the high threshold may be a high score).

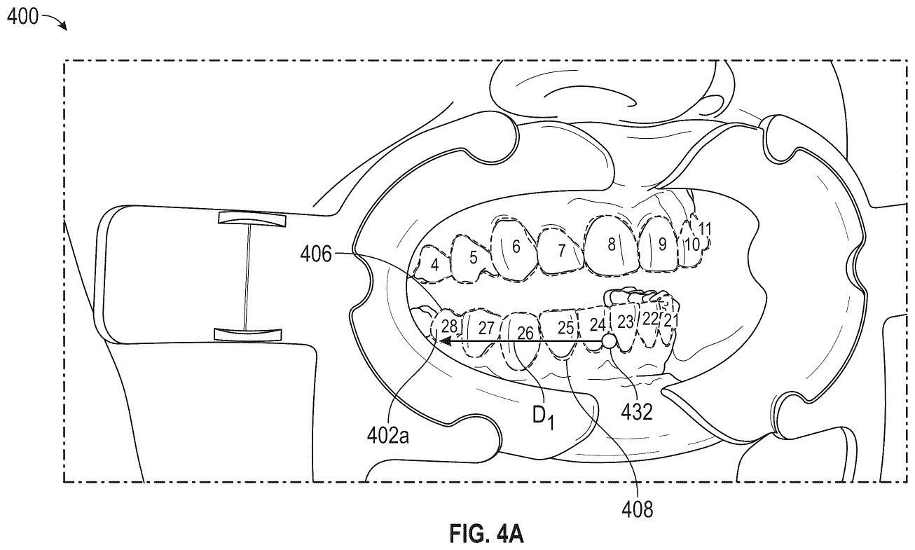

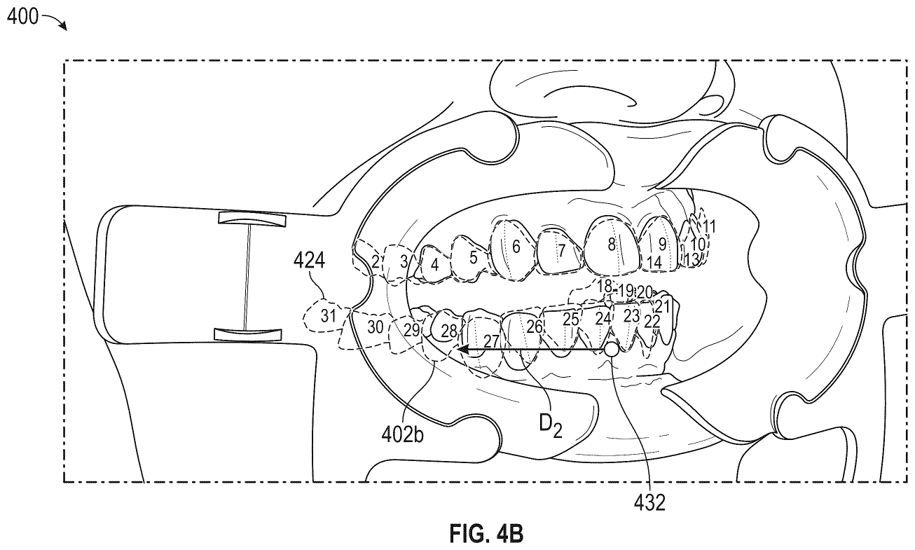

Alternatively or in combination, in some embodiments, the comparison includes comparing tooth locations between the 2D image and the first projection. Teeth that are at the same or similar locations in the 2D image and in the first projection may be considered to have a high likelihood of being the same teeth, whereas teeth that are different locations in the 2D image and in the first projection may be considered to have a low likelihood of being the same teeth. Additional details of this approach are described below, e.g., in connection with FIGS. 4A and 4B.

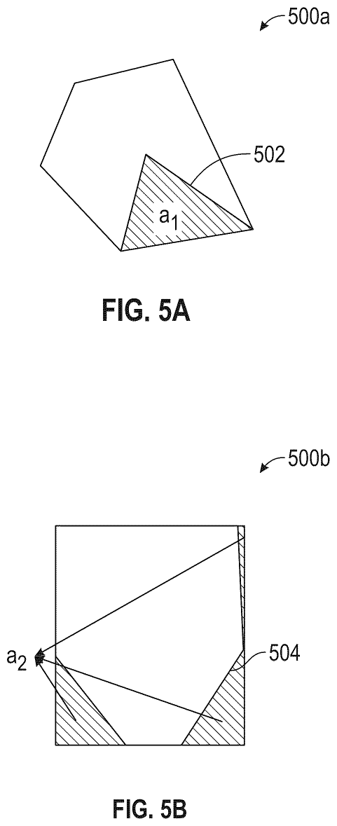

Alternatively or in combination, the comparison can include comparing tooth contour shapes of the first projection of the 3D model and the 2D image. A high degree of similarity between the shape of a tooth in the 2D image and the shape of a tooth in the first projection may indicate that these are likely to be the same tooth, whereas a low degree of similarity may indicate that these are likely to be different teeth. Additional details of this approach are described below, e.g., in connection with FIGS. 5A and 5B.

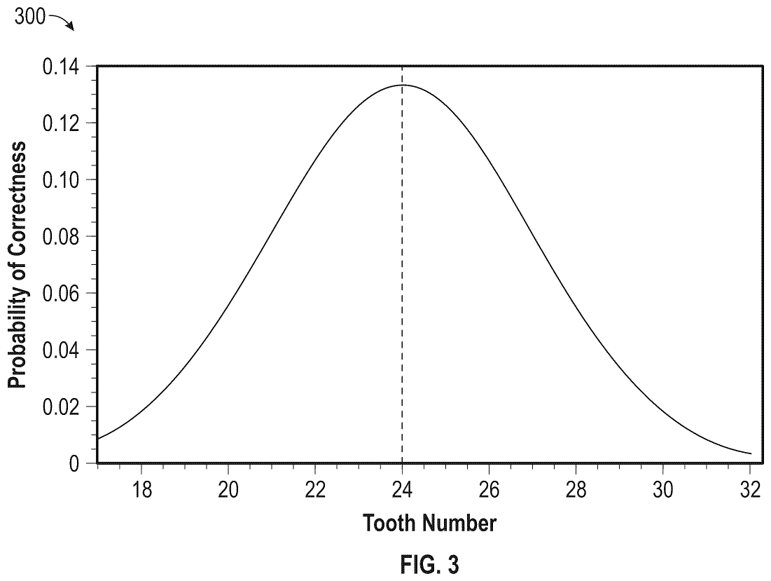

In some embodiments, the probability parameters are determined using an optimization algorithm that, in some embodiments, uses a Bayesian approach. For example, Bayesian probabilities may be calculated and used within a maximum likelihood algorithm to efficiently determine probability parameters for each tooth. More information about an example maximum likelihood algorithm can be found in U.S. Pat. No. 11,357,598, which is incorporated by reference herein in its entirety. As will be described further herein, the optimization algorithm may consider a range of potential tooth identifiers for a tooth in the patient's teeth and output a probable tooth identifier for the tooth. Additional details and examples of techniques for calculating probability parameters using an optimization algorithm that implements a Bayesian approach are provided below with respect to FIGS. 3-5B.

At block 110, the method 100 can include determining a second tooth identification scheme for the patient's teeth in the 2D image. For instance, the second tooth identification scheme may include one or more tooth identifiers that are different from corresponding tooth identifier(s) in the first tooth identification scheme. The different tooth identifier(s) can have a higher likelihood of correctness than the initial tooth identifier(s) assigned by the first tooth identification scheme, such that the second tooth identification scheme can have a higher likelihood of correctness compared to the first tooth identification scheme. In other embodiments, however, the second tooth identification scheme may be the same as the first tooth identification scheme, e.g., if the probability parameters determined in block 108 indicate that the first tooth identification scheme is likely correct.

In some embodiments, the determination of the second tooth identification scheme is based on the probability parameters for the one or more teeth in the image, such as the joint probability parameters across the teeth (e.g., the product of all the probability parameters of the teeth). For instance, the determination may involve identifying a tooth that was assigned a tooth identifier that has a low likelihood of being correct (e.g., the probability parameter is below a predetermined threshold), and selecting a different tooth identifier for the tooth, where the different tooth identifier has a higher likelihood of being correct (e.g., the probability parameter is above the predetermined threshold). In some embodiments, a probability distribution for each of a plurality of teeth is calculated, where the probability distribution for a particular tooth indicates probabilities of that tooth being associated with each of a set of tooth identifiers. For example, a tooth X may have a 70% probability of being tooth #28, a 30% probability of being tooth #27, a 26% probability of being tooth #26, etc. The selected tooth identifier can be the tooth identifier having the highest likelihood of being correct (e.g., #28 has the highest probability and is therefore selected as the identifier for tooth X). Optionally, the selection of a tooth identifier for a tooth may be based in part on the tooth identifiers for one or more other teeth. For example, if a particular tooth identifier is determined to be offset by a particular amount, it may be inferred in some embodiments that all other tooth identifiers for teeth in the same jaw should also be offset by the same amount. The selection of a tooth identifier for a tooth may also be subject to preset constraints and/or boundary conditions. For instance, the range of possible tooth identifiers for an individual tooth may be limited based on the location of the tooth (e.g., it can be assumed that teeth in the upper jaw cannot be assigned tooth identifiers for teeth in the lower jaw, and vice versa); it can be assumed that tooth identifiers must follow a particular order; etc.

In some embodiments, the second tooth identification scheme is determined using an optimization technique, such as an optimization algorithm using a Bayesian approach. For instance, the optimization algorithm may be configured to identify a tooth identification scheme with a maximum posterior probability based on the comparison of the first projection and the 2D image, as will be discussed further below, e.g., with respect to FIGS. 3-5B. In some embodiments, the second tooth identification scheme is determined iteratively, e.g., the 3D model can be repeatedly projected onto the 2D image based on different tooth identification schemes and the result evaluated until the results converge, e.g., the tooth identifiers no longer change. Alternatively, the second tooth identification scheme can be determined without iteration, e.g., a single projection of the 3D model onto the 2D image is sufficient to determine the correct tooth identifiers.

FIG. 2E illustrates the 2D image 200 of FIG. 2A with a corrected tooth identification scheme, in accordance with embodiments of the present technology. The corrected tooth identification scheme can be a second tooth identification scheme 228 that has a higher probability of being correct than the first tooth identification scheme 210 of FIG. 2A. For instance, the second tooth identification scheme 228 can include at least one different tooth identifier than the first tooth identification scheme 210. The at least one different tooth identifier can have a higher likelihood of being correct compared to the corresponding first tooth identifier of the first tooth identification scheme 210. For instance, the tooth identified as tooth #26 in the 2D image 200 of FIG. 2A is now correctly labeled as tooth #27 as in the second tooth identification scheme 228 in the 2D image 200 of FIG. 2E.

Referring again to FIG. 1, at block 112, the method 100 can optionally include outputting a representation of the second tooth identification scheme on a display device. For instance, the second tooth identification scheme can be displayed on a monitor or screen that is associated with a computing device (e.g., a mobile device, personal computer, laptop, tablet, workstation). The computing device can be part of a computing system (e.g., a virtual dental care system) that includes one or more local client devices (e.g., patient devices and/or clinician devices) communicably coupled to a remote server (e.g., of a dental appliance manufacturer and/or a treatment monitoring service provider) via a communications network. In some embodiments, the computing device used to display the second tooth identification scheme is the same as the computing device used to perform the other processes of the method 100, e.g., all of the processes of the method 100 are performed by a local client device. In other embodiments, the computing device used to display the second tooth identification scheme is different than the computing device used to perform the other processes of the method 100, e.g., the second tooth identification scheme is displayed by a local client device and the other processes are performed by a remote server.

The second tooth identification scheme can be displayed as a graphical overlay over the 2D image. For instance, the first tooth identification scheme in the 2D image can be replaced by the second tooth identification scheme. A portion of the 2D image (e.g., a close-up view of the patient's jaws) or the entirety of the 2D image (e.g., the 2D image 200 as shown in FIG. 2E) can be displayed. Additionally or alternatively, the second tooth identification scheme can be displayed alongside the tooth segmentation mask 206 and/or may be displayed in other formats (e.g., in an array, grid, list, etc.). In some embodiments, a user may be able to toggle between different tooth identification schemes (e.g., the first and second tooth identification schemes, and any other candidate identification schemes (e.g., the top candidate identification schemes that have a score or rank greater than a threshold)), and select one or more of the schemes.

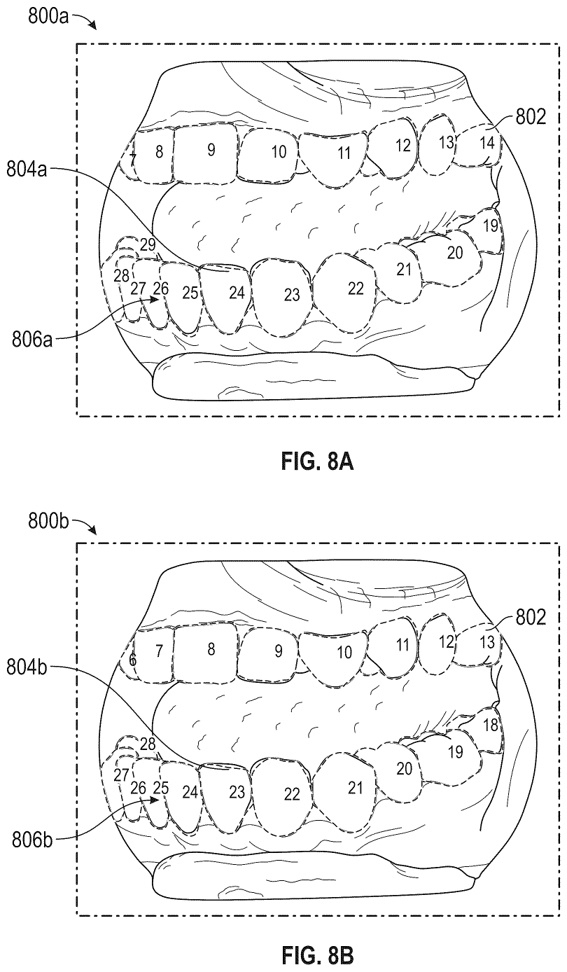

The method 100 illustrated in FIG. 1 can be modified in many different ways. For example, although the above processes of the method 100 are described with respect to a single 2D image, the method 100 can be used to sequentially or concurrently determine tooth identification schemes for any suitable number of images. In some embodiments, the method 100 may use multiple 2D images to enhance the accuracy of tooth identification, as described further herein, e.g., in connection with FIGS. 8A and 8B below. As another example, the ordering of the processes shown in FIG. 1 can be varied (e.g., the process of block 102 may be performed after the process of block 104). In some embodiments, the method 100 may be performed on a remote server. For example, a patient or doctor device (e.g., a smartphone) may be used to capture a 2D image, and this 2D image may be transmitted to the remote server (e.g., via a smartphone application). The remote server may also have the 3D model of the patient's teeth stored therein or may have access to the 3D model. The remote server may then execute the processes of blocks 106-112. In other embodiments, the method 100 may be entirely performed on a local client device (e.g., a mobile device, a personal computer). In some embodiments, some of the steps may be performed on a remote server, and some of the steps may be performed on a local client device. Some of the processes of the method 100 can be omitted (e.g., the process of block 112) and/or the method 100 can include processes not shown in FIG. 1.

For example, the method 100 can optionally include evaluating a condition of the patient's teeth, based on the 2D image and the second tooth identification scheme. For instance, the 2D image and second tooth identification scheme can be received by a dental practitioner, who may assess the 2D image for underlying dental conditions, overall oral health, and/or potential orthodontic procedures. The 2D image and second tooth identification scheme may alternatively or additionally be input into a software algorithm configured to perform automated diagnosis and/or treatment planning based on patient images. In some embodiments, the 2D image is obtained during a dental treatment plan for the patient's teeth. For instance, the patient may be undergoing dental repositioning (e.g., using one or more dental aligners), and the 2D image may be obtained during one or more treatment stages of the dental repositioning. Using the 2D image and the second tooth identification scheme, the progress of the patient's teeth relative to the dental treatment plan can be evaluated (e.g., whether the teeth are in the positions prescribed by the treatment plan or whether the teeth have deviated from the prescribed positions). Further, the 2D image can be input into a machine learning algorithm as training data. For instance, the 2D image may be part of a repository of images used for training a dental AI model. The dental AI model may be configured to predict tooth identifiers, dental conditions, treatment outcomes, etc., from dental images.

As noted above, in some embodiments, the methods for determining and/or correcting tooth identification schemes described herein may utilize an optimization algorithm. The optimization algorithm may use probabilistic (e.g., Bayesian) approaches to determine a correct tooth identification scheme for teeth in a patient image, which (as compared to, e.g., brute force methods) introduces efficiencies that may reduce the processing times and/or resources used for the tasks described herein. For instance, the optimization algorithm may leverage information relevant to a given tooth's identity to deduce the given tooth's probable tooth identifier. In some embodiments, the optimization algorithm uses a prior tooth segmentation mask generated from a patient image, with the assumption that the teeth are segmented correctly in the mask. The input to the optimization algorithm may also include a tooth identification scheme associated with the tooth segmentation mask, which may or may not be correct (although it may be desirable in some instances that the tooth identification scheme be relatively close to being correct).

The optimization algorithm can implement a probabilistic framework based on Bayes' theorem as follows:

$$P ( A \vert B ) = \frac{P ( B \vert A ) ⨯ P ( A )}{P ( B )} ∝ P ( B \vert A ) ⨯ P ( A )$$

where A is a first tooth identification scheme associated with a 2D image, P(A) is the prior probability that the first tooth identification scheme is correct, B is a projection (for instance, a first projection from a 3D model onto the 2D image), P(B) is the probability of observing the projection B, P(B|A) is the likelihood that the projection is correct given the first tooth identification scheme, and P(A|B) is the posterior probability of the first tooth identification scheme being correct given the projection.

Stated differently, the prior probability P(A) may represent the baseline probability that the first tooth identification scheme is correct (e.g., without considering additional data such as the projection of the 3D model), whereas P(A|B) is the posterior probability that the first tooth identification scheme is correct given a projection from a 3D model of the patient's teeth onto the 2D image, the projection being based on the first tooth identification scheme as discussed elsewhere herein. The posterior probability P(A|B) can be directly proportional to the likelihood that the projection is correct P(B|A) and the prior probability that the first tooth identification scheme is correct P(A).

In some embodiments, the goal of the optimization algorithm is to determine the correct tooth identification scheme by finding the set of tooth identifiers that maximizes the posterior probability P(A|B)∝P(B|A)×P(A). This can be accomplished by computing P(A) and P(B|A), as discussed in detail below.

As noted above, the prior probability P(A) represents the baseline probability that the first tooth identification scheme for the 2D image is correct. The prior probability P(A) can be determined in various ways. In some embodiments, for example, the prior probability P(A) can be represented by a Gaussian (e.g., normal) distribution, such that P(A) can be further defined for each tooth of the patient's teeth as:

$$P ( A ) = P ( τ , t ) = \frac{1}{{σ}_{τ} \sqrt{2 π}} {e}^{- \frac{1}{2} {( \frac{τ - t}{{σ}_{τ}} )}^{2}}$$

where τ is a tooth identifier for the tooth in the first tooth identification scheme, t is a candidate identifier from a set of possible tooth identifiers {t} for the tooth, and σ_{τ} is a standard deviation parameter, which can for instance, relate to the degree of confidence that the tooth identifier τ is correct. Accordingly, P(τ, t) is the probability that the tooth assigned the tooth identifier τ in the first tooth identification scheme is actually the tooth identifier t. For instance, P(2, 1) represents the probability that a tooth previously identified as tooth #2 is actually tooth #1. In some instances, probabilities may be calculated only for tooth pairs (τ, t) that are in the same jaw; if τ and t are from different jaws, the probability may simply be set to zero (e.g., assuming that the first tooth identification scheme has correctly assigned the upper and lower jaws). Using the equation above, a prior probability distribution for each tooth can be constructed.

The above equation for the prior probability P(A) may assume that the set of possible tooth identifiers {t} for the tooth is an ordered set of tooth identifiers (e.g., a sequential arrangement of tooth identifiers). Further, it may assume that the tooth identifier τ is at least close to accurate, such that a tooth that is incorrectly identified as tooth #24 is more likely to have a true identity of #23 than a true identity of #5. Alternatively, no such assumption may be made. For instance, P(A) may have a uniform distribution, where tooth identifier #23 is equally likely as tooth identifier #5. Other prior probability distributions (e.g., exponential distributions) may be suitable.

FIG. 3 illustrates an example prior probability distribution 300 of potential tooth numbers for a tooth, in accordance with embodiments of the present technology. In the illustrated example, the probability distribution 300 is for a tooth in the lower jaw, such that the potential tooth numbers range from #17 to #32 (for a tooth in the upper jaw, the potential tooth numbers would range from #1 to #16). As shown in FIG. 3, tooth #24 has the highest probability value, thus indicating that this is believed to be the correct identifier under the first tooth identification scheme. The probabilities are also high for tooth numbers near #24, thus indicating a high likelihood that the first tooth identification scheme could have a small offset error (e.g., the tooth numbers are off by a single tooth or a few teeth). The probabilities are lower for tooth numbers further from #24, thus indicating a low likelihood that the first tooth identification scheme could have a large offset error (e.g., the tooth numbers are off by many teeth).

Additionally or alternatively, other types of probability distributions can be used. For example, a Gaussian probability distribution function may be used, where the kernel of the Gaussian probability distribution is a distance metric between a projected tooth contour from the 3D model and a corresponding tooth contour in the 2D image. The distance metric can include the IoU between the two contours, the difference between contour area sizes, the difference between contour circumferences, etc.

Additionally or alternatively, in embodiments where the first tooth identification scheme is generated using a software algorithm (e.g., a machine learning-based tooth segmentation algorithm), the output of the software algorithm can be used to determine the prior probability distribution. For instance, the tooth segmentation algorithm can generate prior probabilities of each tooth having a certain identity, and the prior probability distribution can be constructed for each tooth. The prior probability distribution may factor in tooth features, e.g., a tooth with a large buccal height may be more likely to be a central incisor having tooth #8 or #9 than a molar having a tooth #30. Likewise, a tooth with a large buccal width may be more likely to be a molar having the tooth number #30 or #18 than a central incisor having tooth number #8.

As noted above, P(B|A) is the likelihood that the projection of the 3D model onto the 2D image is correct given the first tooth identification scheme. This likelihood can correlate the quality of the registration between the projection and the 2D image, e.g., P(B|A) is high if there is good registration and is low if there is poor registration. The quality of registration may correlate to (1) how well the locations of the teeth in the projection and the 2D image match each other, and/or (2) how well the shapes (e.g., contours) of the teeth in the projection and the 2D image match each other.

Accordingly, in some embodiments, the probability P(B|A) can be decomposed into location and contour likelihoods as follows:

$$P ( B \vert A ) = P ( {B}_{l} \vert A ) ⨯ P ( {B}_{c} \vert A )$$

where P(Bₗ|A) is the likelihood of the projection being correct as evaluated based on tooth locations (“location likelihood”), and P(B_{c}|A) is the likelihood of the projection being correct as evaluated based on tooth contours (“contour likelihood”). The location likelihood and contour likelihood may be evaluated separately and subsequently combined to determine the probability P(B|A) (e.g., via multiplication, summing, averaging). The location likelihood and the contour likelihood may be assigned the same weights or may be weighted differently. For instance, the location likelihood may have a lower confidence level due to a low registration score (e.g., particularly if the first tooth identification scheme is incorrect) and thus may be weighted less than the contour likelihood in evaluating P(B|A).

In some embodiments, the location likelihood P(Bₗ|A) is computed as follows:

$$P ( τ , t ) = \frac{1}{{σ}_{l} \sqrt{2 π}} {e}^{- \frac{1}{2} {( \frac{{△}_{τ} - {△}_{t}}{{σ}_{l}} )}^{2}}$$

where τ is the tooth identifier in the first tooth identification scheme, t is a candidate identifier from a set of possible tooth identifiers {t} for the tooth, Δ_{τ} is the relative location of the tooth having the tooth identifier τ, Δ_{τ} is the relative location of the tooth having the candidate tooth identifier t, and σₗ is a standard deviation parameter for tooth location. In some embodiments, the relative location of a tooth is determined with respect to a reference location, such as an anatomical feature of interest (e.g., the jaw center and/or midline). For instance, the relative location of a tooth can be expressed as a distance value or vector from the reference location. Alternatively, the location of a tooth may be determined as an absolute location, such as a set of 2D or 3D coordinates with respect to a global reference frame (e.g., pixels and/or the coordinate system of the 2D image).

FIGS. 4A and 4B illustrate an example location determination for a tooth, in accordance with embodiments of the present technology. Specifically, FIG. 4A illustrates a location determination for a first tooth 402a of a tooth segmentation mask 406 in a 2D image 400, and FIG. 4B illustrates a location determination for a second tooth 402b of a projection 424 in the 2D image 400. Referring first to FIG. 4A, the tooth segmentation mask 406 can be the same or generally similar to the tooth segmentation mask 206 of FIG. 2A. For instance, the tooth segmentation mask 406 includes a plurality of contour lines 408 depicting tooth boundaries. In some embodiments, the location of the first tooth 402a can be expressed in terms of the distance D₁ between the first tooth 402a of the tooth segmentation mask 406 and a reference point 432 (e.g., the center of the jaw).

Turning now to FIG. 4B, the projection 424 can be the same or generally similar to the first projection 224 of FIG. 2. For instance, the projection 424 may be or include a projection of a 3D model of the patient's teeth onto the 2D image 400. Similarly to FIG. 4A, the location of the second tooth 402b can be expressed in terms of the distance D₂ between the second tooth 402b of the projection 424 and the reference point 432 (e.g., the center of the jaw). The distance D₂ can be compared to the distance D₁ to determine if the first tooth 402a and the second tooth 402b are at the same or different locations. If the first tooth 402a and the second tooth 402b are at the same (or substantially the same) location, then the first tooth 402a and the second tooth 402b may be determined to have an increased likelihood of being the same tooth and the tooth identifier may thus be determined more likely to be correct. Conversely, if the first tooth 402a and the second tooth 402b are at different locations, then the first tooth 402a and the second tooth 402b may be determined to have a decreased likelihood of being the same tooth and the tooth identifier may thus be determined more likely to be incorrect. As depicted, the distance D₂ is less than the distance D₁, therefore these are likely not the same tooth and the tooth identifier is likely incorrect.

In some embodiments, the contour likelihood P(B_{c}|A) is computed as follows:

$$P ( τ , t ) = {\prod }_{i = 1}^{n} \frac{1}{{σ}_{i} √ 2 π} {e}^{- \frac{1}{2} {( \frac{{f}_{τ , i} - {f}_{t , i}}{{σ}_{i}} )}^{2}}$$

where τ is the tooth identifier of the first tooth identification scheme, t is a candidate identifier from a set of possible tooth identifiers {t} for the tooth, i is the feature index for a plurality of contour shape features, f is a contour feature measure, σᵢ is a standard deviation parameter for the contour shape feature i, and n is the total number of contour shape features of interest.

In some embodiments, the contour shape features are used to compare a tooth segmentation mask (e.g., the tooth segmentation mask 206 of FIG. 2A) and a projection (e.g., the first projection 224 of FIG. 2C). For instance, a first tooth contour shape for a first tooth can be determined based on the tooth segmentation mask (or a 2D image), and one or more second tooth contour shapes for one or more second teeth can be determined based on the projection. The contour shape features can be determined for each of the first and second contour shapes. In some embodiments, the contour shape features include size (e.g., as a function of area), contour edge length (e.g., perimeter), contour width, contour height, mean distance between contour edge points and the centroid of the contour, standard deviation of the distances between contour edge points and the centroid of the contour, a concavity metric (e.g., a size of a concave area of the tooth, a length of a concave edge of the tooth), and/or a convexity metric (e.g., a size of a convex area of the tooth, a length of convex edge of the tooth). In some embodiments, the contour shape features are normalized by the average tooth size as determined in the tooth segmentation mask and/or projection. Further, some or all of the contour shape features can be largely or entirely translation, rotation, and/or scale invariant.

Alternatively or in combination, the first and second tooth contour shapes can be compared directly. For instance, an mIoU can be determined between the first tooth contour shape and the one or more second tooth contour shapes, as described elsewhere herein. The mIoU can then be compared to a threshold mIoU. In cases where the mIoU exceeds the threshold mIoU, the contour likelihood may be high. In contrast, when the mIoU does not exceed the threshold mIoU, the contour likelihood may be low.

To illustrate the contour shape features, representative formulas are provided herein. For example, the size of the tooth contour (r) can be expressed as:

$$r = \sqrt{\frac{a}{π}}$$

where a is the area of a tooth contour. Significant differences between the tooth contour size of a tooth in the tooth segmentation mask and the tooth contour size of a corresponding tooth in the projection may indicate that these are not actually the same teeth, and that the tooth identifier for the tooth segmentation mask is likely incorrect.

The contour shape features can include a concavity metric, such as a degree of concavity of a tooth. For example, FIG. 5A is an illustration of an example tooth shape 500a including a concave edge 502, in accordance with embodiments of the present technology. The degree of concavity of the tooth shape 500a can be evaluated based on an area a₁ that is bounded by the concave edge 502 and a line drawn between the endpoints of the concave edge 502. The area a₁ may be determined by connecting relevant tooth contour boundary points of the tooth shape 500a, such that the resulting contour becomes convex (e.g., finding the minimal convex hull covering the original tooth contour).

In some embodiments, the degree of concavity is measured in terms of a concave region size (δ_{c}), which can be expressed as:

$${δ}_{c} = \sqrt{\frac{{a}_{1}}{π}}$$

Significant differences between the degree of concavity of a tooth in the tooth segmentation mask and the degree of concavity of a corresponding tooth in the projection may indicate that these are not actually the same teeth, and that the tooth identifier for the tooth segmentation mask is likely incorrect.

The contour shape features can also include a convexity metric, such as a degree of convexity of a tooth. For example, FIG. 5B is an illustration of an example tooth shape 500b including a convex edge 504, in accordance with embodiments of the present technology. The degree of convexity of the tooth shape 500b can be evaluated based on one or more areas a₂ that are bounded by the convex edge 504 and an outer boundary around the tooth shape 500b. The area a₂ may represent the difference between the minimal rectangular bounding box for the tooth shape 500b and the tooth contour represented by the tooth shape 500b.

In some embodiments, the degree of convexity is measured in terms of a convex region size (δᵥ), which can be expressed as:

$${δ}_{v} = \sqrt{\frac{{a}_{2}}{π}}$$

Significant differences between the degree of convexity of a tooth in the tooth segmentation mask and the degree of convexity of a corresponding tooth in the projection may indicate that these are not actually the same teeth, and that the tooth identifier for the tooth segmentation mask is likely incorrect.

While the probability P(B|A), has been expressed in terms of the location likelihood P(Bₗ|A) and the contour likelihood P(B_{c}|A), other likelihood components may alternatively or additionally be included. For instance, the probability P(B|A), may additionally or alternatively include camera pose likelihood. The camera pose likelihood may be determined via the projection of the 3D model onto the 2D image, e.g., if the registration process produces camera parameters that are unlikely to practical (e.g., too close or too far from the patient), this may mean that the projection has lower likelihood of being correct.

In some embodiments, various parameters in the optimization algorithm can be tuned, such as the standard deviation parameters (e.g., σ_{τ}). These parameters can be tuned manually, or may be tuned automatically using optimization approaches, e.g., such that the resulting standard deviation parameters lead to improved accuracy in the final predictions of tooth identifiers.

In some embodiments, the optimization algorithm provides a flexible method for identifying teeth. For instance, by decomposing the tooth identification process into prior and likelihood components through Bayes' theorem, each of the likelihood components can be independently selected, assessed, and combined to provide the posterior probability P(A|B). Further, the optimization algorithm may have improved interpretability since each likelihood component of the optimization algorithm can be explicitly defined, and thus can be traced and evaluated.

In some embodiments, the methods for tooth identification herein utilize a “single pass” approach, in which a second (e.g., corrected) tooth identification scheme is produced without multiple iterations. This approach may be applicable if the second tooth identification scheme has a high likelihood of being correct and thus does not need additional validation and/or modification. For instance, the optimization algorithms described herein may be able to determine the correct tooth identification scheme with high accuracy and therefore a single iteration of the algorithm is sufficient. In other embodiments, however, iteration may be desirable, e.g., to ensure that the algorithm has converged on a satisfactory and/or optimal result, to validate the accuracy of the tooth identification, to make additional corrections to the tooth identification scheme, etc. For example, certain optimization algorithms (e.g., expectation-maximization (EM) algorithms) may identify the correct tooth identification scheme via iteration, rather than via a single pass.

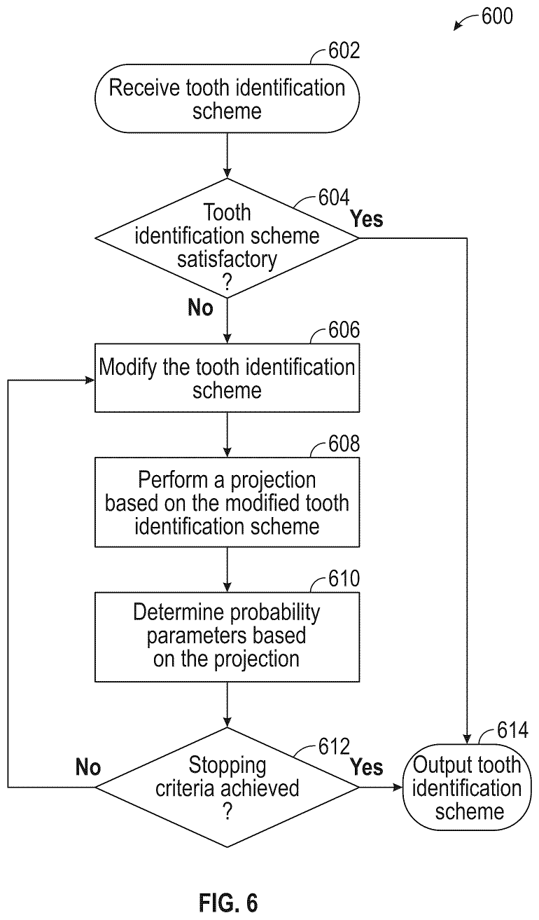

FIG. 6 is a flow diagram illustrating a method 600 for identifying teeth in a patient image, in accordance with embodiments of the present technology. The method 600 can be used to iteratively evaluate and modify tooth identifiers until a satisfactory tooth identification scheme is achieved (e.g., a scheme that has a high likelihood of being correct). In some embodiments, some or all of the processes of the method 600 are implemented as computer-readable instructions (e.g., program code) that are configured to be executed by one or more processors of a computing device (e.g., a mobile device, laptop, personal computer, workstation, remote server). The method 600 may be combined with any of the other methods described herein, such as the method 100 of FIG. 1.

The method 600 can begin at block 602 with receiving a tooth identification scheme. The tooth identification scheme can be generated using any of the methods described herein, such as a Bayesian-based optimization algorithm or other optimization algorithm. In some embodiments, the tooth identification scheme is the second tooth identification scheme of the method 100 of FIG. 1.

At block 604, the method 600 can determine whether the tooth identification scheme is satisfactory (e.g., likely to be correct). In some embodiments, the determination is based on one or more stopping criteria for the method 600, where the stopping criteria can include one or more of the following: whether the likelihood of the tooth identification scheme being correct is above a threshold value, whether a registration based on the tooth identification scheme has a registration score above a threshold value, whether a posterior probability associated with the tooth identification scheme is above a threshold value, whether a minimum number of iterations has been performed, whether a maximum number of iterations has been reached, whether the likelihood, registration score, and/or posterior probability has not changed (e.g., increased or decreased significantly) from a previous iteration, whether the output tooth identification scheme is the same as the input tooth identification scheme at the current iteration, etc.

If the tooth identification scheme is satisfactory, the method 600 can proceed to block 614 with outputting the tooth identification scheme (e.g., as previously described in connection with block 112 of the method 100 of FIG. 1).

If the tooth identification scheme is not satisfactory, the method 600 can proceed to block 606 with modifying the tooth identification scheme by changing one or more tooth identifiers. In some embodiments, the process of block 606 includes identifying a first tooth identifier having a low likelihood of being correct (e.g., the probability parameter for the first tooth identifier is below a threshold value and/or is lower than the probability parameters for one or more other tooth identifiers). The process of block 606 can include replacing the first tooth identifier with a second tooth identifier having a higher likelihood of being correct (e.g., the probability parameter for the second tooth identifier is higher than the probability parameter for the first tooth identifier, is higher than a threshold value, and/or is the maximum probability parameter for the corresponding tooth). In some embodiments, this may include replacing the first tooth identifier with a tooth identifier that has a maximum intersection (e.g., IoU) in the registration for the given tooth.

Alternatively or in combination, the process of block 606 can involve shifting the tooth identification scheme to the left or to the right by one tooth (a common error). Alternatively or in combination, the process of block 606 can involve calculating an offset direction, such as by computing one or more vectors between the teeth in the 2D image and the teeth in the projection of the 3D model (e.g., based on crown centers or other anatomical reference locations), and then shifting the tooth identification scheme in the offset direction. The computed vectors may optionally be used to calculate the shift magnitude (e.g., the length of the vector may correlate to the amount of offset to be applied).

Optionally, the process of block 606 may consider certain constraints on the potential modifications, e.g., the range of possible tooth identifiers for an individual tooth may be limited based on the location of the tooth, it can be assumed that tooth identifiers must follow a particular order, the same offset must be applied to all teeth in the same jaw, etc. Moreover, in embodiments where the image depicts both jaws of the patient and joint-jaw registration is performed, the tooth identification scheme for one jaw may affect the tooth identification scheme of the other jaw, e.g., if the tooth identification scheme for one jaw is likely to be correct, then anatomical constraints limit the range of possible tooth identification schemes for the other jaw. For instance, the lower jaw may be more likely to have a rotational movement about the temporomandibular joint rather than a left or right translation, and this information may aid with registration of the upper jaw and/or be used to eliminate tooth identification schemes that would likely be incorrect.

At block 608, the method 600 can continue with performing a projection based on the modified tooth identification scheme. The process of block 608 can be generally similar to the process of block 106 of the method 100 of FIG. 1. For example, the projection can include projecting a 3D model of the patient's teeth onto a 2D image of the teeth, based on the modified tooth identification scheme. In some embodiments, the 3D model is registered to the 2D image of the teeth, and the modified tooth identification scheme is used to determine an initial estimate for the registration parameters and/or to match teeth from the 3D model to the teeth of the 2D image for the registration.

At block 610, the method 600 can include determining one or more probability parameters based on the projection. The process of block 610 can be generally similar to the process of block 108 of the method 100 of FIG. 1. For example, the projection can be compared to the 2D image to determine a probability parameter for each of one or more teeth in the 2D image, where the probability parameter indicates a likelihood that a tooth identifier for the corresponding tooth in the 2D image is correct. In some embodiments, the probability parameter indicates whether a tooth identifier provided by the modified tooth identification scheme is likely to be correct or incorrect. In some embodiments, the probability parameter is a global probability parameter representing the overall likelihood that the modified tooth identification scheme across all of the patient's teeth is correct. The probability parameter may be determined based on a registration score, using a Bayesian-based optimization algorithm or other optimization algorithm, and/or any of the other techniques described herein.

At block 612, the method 600 can determine whether one or more stopping criteria have been achieved. The stopping criteria can include one or more of the following: whether the likelihood of the modified tooth identification scheme being correct is above a threshold value, whether a registration based on the modified tooth identification scheme has a registration score above a threshold value, whether a posterior probability associated with the modified tooth identification scheme is above a threshold value, whether the modified tooth identification scheme is the same as the modified tooth identification scheme from a previous iteration of the method 600, whether the probability parameters for the modified tooth identification scheme are substantially the same as the probability parameters calculated in a previous iteration of the method 600, whether the probability parameters are converging, whether a minimum number of iterations has been performed, whether a maximum number of iterations has been reached, etc.

If the stopping criteria have been achieved, the method 600 can proceed to block 614 with outputting the modified tooth identification scheme (e.g., as previously described in connection with block 112 of the method 100 of FIG. 1).

If the stopping criteria have not been achieved, the method 600 can return to block 606 with modifying the tooth identification scheme. The modified tooth identification scheme can then be reevaluated according to the processes of blocks 606-612. This procedure can be iterated to produce a tooth identification scheme that has a high likelihood of being correct.

In some embodiments, the processes of blocks 606-612 can be used to generate and evaluate multiple modified tooth identification schemes in a single iteration. For instance, first and second modified tooth identification schemes can be generated in a single iteration. The second modified tooth identification scheme may include at least one tooth identifier different from the first modified tooth identification scheme. The first and second modified tooth identification schemes can be evaluated according to the processes of blocks 606-612, e.g., both the first and second modified tooth identification schemes can be compared with the stopping criteria of block 612. Alternatively or in combination, the first and second modified tooth identification schemes can be compared with each other, such that the higher probability tooth identification scheme of the first and second modified tooth identification schemes is selected for further evaluation and/or outputting. For instance, probability parameters can be compared between the first and second modified tooth identification schemes, and the modified tooth identification scheme with the higher likelihood of being correct can be output in block 614. This may be advantageous in situations where the possible modifications to the tooth identification scheme are limited, e.g., a limited number of modified tooth identification schemes can be produced such as shifting tooth identifiers to the left in the first modified tooth identification scheme and shifting tooth identifiers to the right in the second modified tooth identification scheme.

In some embodiments, the initial tooth identification scheme generated by manual or automated annotation may not be sufficiently reliable for registration purposes, or may even be missing. Further, the confidence level of a tooth identification scheme generated by manual or automated annotation may be affected by the quality of the 2D image. In particular, lighting conditions (e.g., low lighting, bright lighting, glare, reflections), anatomical considerations (e.g., dark spots on one or more teeth, short crowns (such as crowns of primary teeth), obscured teeth, indistinguishable tooth shapes), camera issues (e.g., blur, poor focus), etc., may result in quality issues in the 2D image that interfere with the accuracy of manual or automated annotation.

Accordingly, in some embodiments, the present technology provides methods for tooth identification that do not rely on an initial tooth identification scheme generated by manual or automated annotation. Such methods may be used, for instance, if the confidence level in the initial tooth identification scheme is too low (e.g., below a threshold value), if quality issues are detected to be present in the 2D image, and/or if an initial tooth identification scheme is not provided. In such embodiments, the methods can use a comparison of tooth shapes to project the 3D model onto the 2D image.

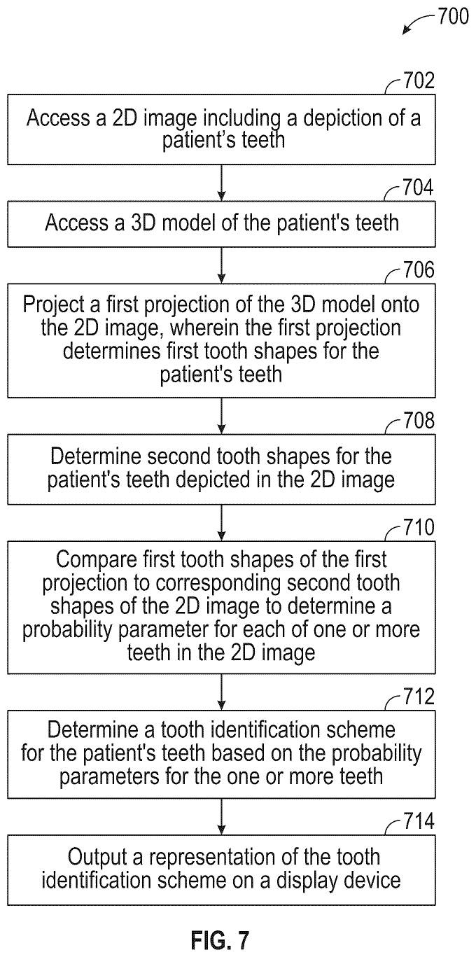

FIG. 7 is a flow diagram illustrating a method 700 for identifying teeth in a patient image, in accordance with embodiments of the present technology. The method 700 can be used to determine a tooth identification scheme for the teeth without requiring an initial tooth identification scheme from another source. In some embodiments, some or all of the processes of the method 700 are implemented as computer-readable instructions (e.g., program code) that are configured to be executed by one or more processors of a computing device (e.g., a mobile device, laptop, personal computer, workstation, remote server). The method 700 may be combined with any of the other methods described herein, such as the method 100 of FIG. 1 and/or the method 600 of FIG. 6.

The method 700 can begin at block 702 with accessing a 2D image including a depiction of a patient's teeth. The process of block 702 can be generally similar to the process of block 102 of the method 100 of FIG. 1, except that the 2D image does not need to be annotated with tooth identifiers. In some embodiments, the 2D image includes or is associated with a tooth segmentation mask having a plurality of segmented regions corresponding to individual teeth, but there is no tooth identification scheme for the tooth segmentation mask. In other embodiments, there is a tooth identification scheme for the tooth segmentation mask, but that tooth scheme identification scheme is determined to have a low confidence level (e.g., due to image quality issues) and thus is disregarded in the subsequent processes of the method 700.

At block 704, the method 700 can continue with accessing a 3D model of the patient's teeth. The process of block 704 can be identical or generally similar to the process of block 104 of the method 100 of FIG. 1.

At block 706, the method 700 can include projecting a first projection of the 3D model onto the 2D image. The projection can be performed as previously described with respect to block 106 of the method 100 of FIG. 1. For example, the 3D model can be registered to the 2D image to determine a spatial mapping between the 3D reference frame of the 3D model and the 2D reference frame of the 2D image, and the spatial mapping is used to project the 3D model into the 2D reference frame of the 2D image. The registration can be performed, for example, by matching one or more teeth in the 3D model to one or more teeth in the 2D image, e.g., based on edges, shapes, location, etc. Alternatively or in combination, the registration can involve projecting the 3D model into the 2D reference frame, e.g., based on knowledge of the imaging parameters for the 2D image, and/or by projecting the 3D model according to a plurality of different simulated imaging parameters and selecting the set of imaging parameters that produce the greatest similarity between the projected 3D model and the 2D image. For instance, the 3D model may be registered to the 2D image by iteratively projecting the 3D model onto the 2D image and adjusting virtual camera parameters until the registration is satisfactory. The registration can be performed using any suitable 3D to 2D registration algorithm.

In some embodiments, the first projection of the 3D model is used to determine one or more first tooth shapes for the patient's teeth. The first tooth shapes can be the 2D shapes (e.g., contours, areas) of the teeth in the first projection of the 3D model. Stated differently, the first tooth shapes can provide a 2D representation of the shapes of the teeth of 3D model when viewed according to the camera parameters from the registration.

At block 708, the method 700 can continue with determining one or more second tooth shapes for the patient's teeth depicted in the 2D image. The second tooth shapes can depict the contours and/or areas of the teeth in the 2D image. In some embodiments, the second tooth shapes include or are based on a tooth segmentation mask for the 2D image.

At block 710, the method 700 can include comparing one or more first tooth shapes of the first projection to one or more corresponding second tooth shapes of the 2D image to determine a probability parameter for each of one or more teeth in the 2D image. The comparison process can include matching a tooth in the 2D image to a corresponding tooth in the first projection, and then comparing the tooth shapes of the matched teeth to determine the degree of similarity. The matching can be based on one or more shape features such as tooth size, contour edge length, contour width, contour height, mean distance between the contour edge points and a centroid of the contour, standard deviation of distances between contour edge points and the centroid of the contour, a concavity metric, a convexity metric, etc.

The probability parameter may represent the likelihood that the matched teeth are actually the same teeth. The probability parameter can be based on the shape comparison, e.g., a high degree of shape similarity can indicate that the teeth are likely to be the same tooth, whereas a low degree of shape similarity can indicate that the teeth are likely to be different teeth. The probability parameter can be a quantitative value, a qualitative parameter, or suitable combinations thereof. Probability parameters may be computed for all of the teeth in the 2D image or only a subset of the teeth (e.g., only teeth that are clinically relevant for diagnosis and/or treatment, only teeth are sufficiently visible, only teeth near the center of the image).

Alternatively or in combination, the probability parameter may represent the likelihood that a tooth identifier for a tooth in the 2D image is correct. For instance, in embodiments where the teeth of the 3D model are associated with a model tooth identification scheme that provides model tooth identifiers for each tooth, the probability parameter can indicate the likelihood that a tooth in the 2D image matches a corresponding tooth in the first projection of the 3D model, and thus, the likelihood that the corresponding model tooth identifier is the correct tooth identifier for the tooth in the 2D image. As an example, if a tooth in the 2D image has a high degree of shape similarity to tooth #27 in the first projection of the 3D model, then there is a high likelihood that the tooth in the 2D image is also tooth #27. Conversely, if a tooth in the 2D image has a low degree of shape similarity to tooth #27 in the first projection of the 3D model, then there is a low likelihood that the tooth in the 2D image is tooth #27.

At block 712, the method 700 can include determining a tooth identification scheme for the patient's teeth based on the probability parameters for the one or more teeth. For instance, the determination may involve selecting a tooth identifier for each tooth that has a high likelihood of being correct (e.g., the tooth identifier is associated with a probability parameter that is above a threshold value). In embodiments where multiple tooth identifiers are possible for an individual tooth, the selected tooth identifier can be the tooth identifier having the highest likelihood of being correct (e.g., the largest probability parameter). The selection of a tooth identifier for a tooth may be subject to preset constraints and/or boundary conditions. For instance, the range of possible tooth identifiers for an individual tooth may be limited based on the location of the tooth (e.g., it can be assumed that teeth in the upper jaw cannot be assigned tooth identifiers for teeth in the lower jaw, and vice versa); it can be assumed that tooth identifiers must follow a particular order; etc. In some embodiments, tooth identifiers are assigned concurrently and jointly across all teeth to avoid conflicts (e.g., two teeth getting assigned the same identifier) and logically impossible assignments (e.g., physically impossible ordering such as #7, #9, #8 across three consecutive teeth).

In some embodiments, the tooth identification scheme is determined using an optimization technique, such as a Bayesian-based optimization algorithm as described herein.

In some embodiments, the tooth identification scheme is determined without iteration, e.g., a single projection of the 3D model onto the 2D image is sufficient to determine the correct tooth identifiers. Alternatively, the tooth identification scheme may be determined iteratively. For instance, an initial tooth identification scheme can be generated based on a comparison of tooth shapes as described above. The initial tooth identification can then be iteratively evaluated and modified until stopping criteria are achieved, e.g., as previously described with respect to the method 600 of FIG. 6.

At block 714, the method 700 can optionally include outputting a representation of the tooth identification scheme on a display device. The process of block 714 can be identical or generally similar to the process of block 112 of the method 100 of FIG. 1.

The method 700 illustrated in FIG. 7 can be modified in many different ways. For example, although the above processes of the method 700 are described with respect to a single 2D image, the method 700 can be used to sequentially or concurrently determine tooth identification schemes for any suitable number of images. As another example, the ordering of the processes shown in FIG. 7 can be varied (e.g., the process of block 702 may be performed after the process of block 704, the process of block 708 may be performed at any point before the process of block 710). Some of the processes of the method 100 can be omitted (e.g., the process of block 714) and/or the method 100 can include processes not shown in FIG. 7 (e.g., evaluating a condition of the patient's teeth based on the 2D image and the tooth identification scheme as discussed above).

As previously noted, the methods for tooth identification described herein may be combined. As an example, it may be useful to consider both previous tooth identification schemes, e.g., as described by the processes of the method 100 of FIG. 1, and tooth contour shapes, e.g., as described by the processes of the method 700 of FIG. 7, in identifying and correcting a tooth identification scheme in a patient image. For instance, a corrected tooth identification scheme can be determined based on an initial tooth identification scheme in a patient image, in accordance with the processes of the method 100 of FIG. 1. Additionally, a contour-based tooth identification scheme can be determined from the patient image using tooth contour shapes alone (e.g., without considering the initial tooth identification scheme), in accordance with the processes of the method 700 of FIG. 7. The first corrected tooth identification scheme and the contour-based tooth identification scheme can be evaluated, e.g., in accordance with blocks 608-612 of the method 600 of FIG. 6, such that one of the first corrected tooth identification scheme and the contour-based tooth identification scheme is determined to be the correct tooth identification scheme for the patient image.

Alternatively or in combination, the first corrected tooth identification scheme and the contour-based tooth identification scheme can be combined to produce a final tooth identification scheme. In some embodiments, the combination of the tooth identification schemes may consider weights for each of the corrected tooth identification scheme and the contour-based tooth identification scheme. For instance, in situations where the patient image includes image quality issues, the confidence level in the corrected tooth identification scheme may be low, and the contour-based tooth identification scheme may be assigned a higher weight. In such cases, inconsistencies between the corrected tooth identification scheme and the contour-based tooth identification scheme may be resolved by including information from the contour-based tooth identification over the corrected tooth identification scheme. As another example, in situations where the tooth contours are not clearly defined in the patient image, the confidence level in the contour-based tooth identification scheme may be low and the corrected tooth identification scheme may take precedence.

Optionally, the weights may be adjusted based on the evaluations of the corrected tooth identification scheme and/or the contour-based tooth identification scheme. For instance, an evaluation of the corrected tooth identification scheme may indicate that the probability of the corrected tooth identification scheme being correct is low and/or not improving (e.g., in an iterative process), and therefore weights should be reassigned to decrease the importance of the corrected tooth identification scheme in determining the final tooth identification scheme. In such cases, another evaluation may begin by considering the contour-based tooth identification scheme over the corrected tooth identification scheme, etc. A suitable combination of the tooth identification schemes may be used, such as 50% corrected tooth identification scheme and 50% contour-based tooth identification scheme, 75% corrected tooth identification scheme and 25% contour-based tooth identification scheme, 0% corrected tooth identification scheme and 100% contour-based tooth identification scheme, etc.

Although certain embodiments of the present technology are described in connection with identifying patient teeth using a single patient image, this is not intended to be limiting, and the present technology can also be used to identify teeth using multiple patient images, such a plurality of photographs, image frames of a video, etc. For example, any of the methods herein can involve accessing two or more 2D images depicting a patient's teeth, where some or all of the images are different from each other, e.g., depict the patient's teeth from different views, depict different subsets of the teeth, are obtained at different points in time, etc. The information from multiple 2D images can be used to enhance the accuracy of the determined tooth identification scheme for the teeth in the images.

For example, FIG. 8A illustrates a first 2D image 800a of a patient's teeth 802, and FIG. 8B illustrates a second 2D image 800b of the patient's teeth 802, in accordance with embodiments of the present technology. The first and second 2D images 800a, 800b can be two image frames of a video of the patient's teeth 802. The image frames may be consecutive image frames (e.g., frame n and frame n+1), or may be non-consecutive image frames that are separated by one or more intervening frames (e.g., frame n and frame n+1+x, where x is the number of intervening frames). Alternatively, the first and second 2D images 800a, 800b can be two photographs of the patient's teeth 802. In some embodiments, the selection of the first and second 2D images 800a, 800b is subject to thresholds that constrain which images may be used for tooth identification purposes, e.g., to ensure that the first and second 2D images 800a, 800b are sufficiently close in time and/or similar to each other. For instance, the first and second 2D images 800a, 800b may be within x frames of each other, obtained within y seconds of each other, obtained with a viewing angle that is within z degrees of each other, etc.

The first and second 2D images 800a, 800b can be obtained at different points in time, e.g., the first 2D image 800a can be obtained at least 100 milliseconds, 200 milliseconds, 500 milliseconds, 1 second, 2 second, 5 second, 10 seconds, etc., before the second 2D image 800b. In some instances, the patient's teeth 802 and/or the imaging device may have moved during this time period, such that the depiction of the patient's teeth 802 in the first 2D image 800a can be different than the depiction of the patient's teeth 802 in the second 2D image 800b. For instance, at least some of the teeth 802 may be at different locations and/or have different shapes in the first 2D image 800a versus the second 2D image 800b, different subsets of the teeth 802 may be visible in the first 2D image 800a versus the second 2D image 800b, etc.

In the illustrated embodiment, the first 2D image 800a is associated with a first tooth segmentation mask 804a (shown as broken lines) and a first tooth identification scheme 806a, and the second 2D image 800b is associated with a second tooth segmentation mask 804b (shown as broken lines) and a second tooth identification scheme 806b. The tooth identification schemes 806a, 806b may be generated via manual or automated annotation, and thus may contain errors due to inaccuracies in the annotation process. For example, as shown in FIGS. 8A and 8B, the first tooth identification scheme 806a is offset from the second tooth identification scheme 806b by one tooth (e.g., the tooth labeled #11 in the first 2D image 800a is labeled #10 in the second 2D image 800b).

In some embodiments, a first tooth identification scheme for a first 2D image is compared to a second tooth identification scheme from a second 2D image, and the comparison is used to detect errors in one or both tooth identification schemes. The process can include, for example, matching a tooth in the first tooth identification scheme to a tooth in the second tooth identification scheme (e.g., based on size, shape, location, tooth identifier), and comparing the matched teeth to detect discrepancies. Discrepancies in the tooth identifiers for the matched teeth may indicate an error in one or both tooth identification schemes. For example, referring again to FIGS. 8A and 8B, tooth #11 in the first 2D image 800a is visually the same as tooth #10 in the second 2D image 800b (e.g., they have substantially the same shape and are at substantially the same location), so at least one of these tooth identifiers is incorrect. Similarly, significant discrepancies in the size, shape, and/or location of matched teeth may indicate an error in one or both tooth identifications. For instance, as shown in FIGS. 8A and 8B, the shape and location of tooth #11 in the first 2D image 800a differs significantly from the shape and location of tooth #11 in the second 2D image 800b, so at least one of these tooth identifiers is incorrect.

The detected discrepancies can be used to determine the correct tooth identification scheme for the first and second 2D images. In some embodiments, for example, the teeth in the first 2D image can be matched to the teeth in the second 2D image based on tooth features such as shape, size, location, etc. This matching can be used to combine information across both the first and second 2D images to determine the correct tooth identifiers for both images. For instance, a first set of probability parameters can be determined for one or more teeth in the first 2D image, where the first set represents the correctness likelihood of each of the potential tooth identifiers for each tooth; and a second set of probability parameters can be determined for the corresponding one or more teeth in the second 2D image, where the second set represents the correctness likelihood of each of the potential tooth identifiers for each tooth. The first and second sets can be combined with each other (e.g., by multiplication, summing, averaging) to combine these probability parameters, and the correct tooth identification scheme can be determined by selecting the tooth identifiers for the teeth associated with the maximum probability parameters. Optionally, in embodiments where different sets of teeth are visible in the first and second 2D image, the probability parameters may be combined only for those teeth are present in both images.

Alternatively or in combination, information from the first and second 2D images may be used in an iterative algorithm (e.g., an optimization algorithm) to converge on the correct set of tooth identifiers. For example, a first projection of a 3D model of the patient's teeth can be projected onto the first 2D image based on the first tooth identification scheme, and a second projection of the 3D model can be projected onto the second 2D image based on the second tooth identification scheme (e.g., as previously described with respect to block 106 of the method 100 of FIG. 1). The first projection can be compared to the first 2D image to determine a first probability parameter for one or more teeth in the first 2D image, and the second projection can be compared to the second 2D image to determine a second probability parameter for one or more teeth in the second 2D image (e.g., as previously described with respect to block 108 of the method 100 of FIG. 1). Subsequently, a first updated tooth identification scheme can be determined based on the first probability parameters, and a second updated tooth identification scheme can be determined based on the second probability parameters (e.g., as previously described with respect to block 110 of the method 100 of FIG. 1). The first and second updated tooth identification schemes may be generated concurrently using both the first and second probability parameters and using information indicating correspondences between teeth in the first 2D image and teeth in the second 2D image. If the first and second updated tooth identification schemes are consistent with each other, this may indicate that these schemes are accurate. Conversely, if there are still discrepancies between the first and second updated tooth identification schemes, this may indicate that inaccuracies are still present in one or both schemes, in which case further modification and evaluation can be performed on these schemes in parallel (e.g., in accordance with the method 600 of FIG. 6) until the schemes are consistent with each other and/or until a quality threshold is reached. Optionally, if discrepancies are present, information from one or more additional 2D images can be used to resolve the discrepancy (e.g., a third tooth identification scheme from a third 2D image can be considered and compared to the tooth identification schemes of the first and second 2D images).

In some embodiments, the information from an earlier image is used to determine the correct tooth identification scheme from a later image. For instance, a correct tooth identification scheme for the first 2D image can be obtained using the methods described herein. The correct tooth identification scheme for the first 2D image can then be used to determine the correct tooth identification for the second 2D image more efficiently, e.g., the tooth identifiers from the first 2D image can be applied directly to the corresponding teeth in the second 2D image. However, there may still be value in independently determining the correct tooth identification scheme in the second 2D image, since the second 2D image may depict different teeth, additional teeth, a different viewing angle, etc., compared to the first 2D image.

### II. Dental Appliances and Associated Methods

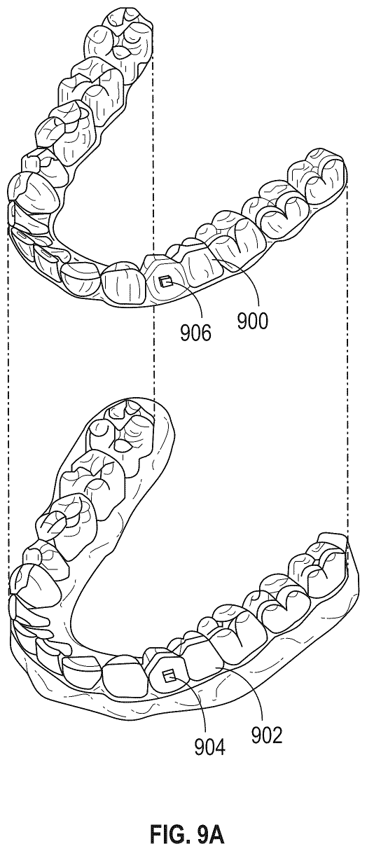

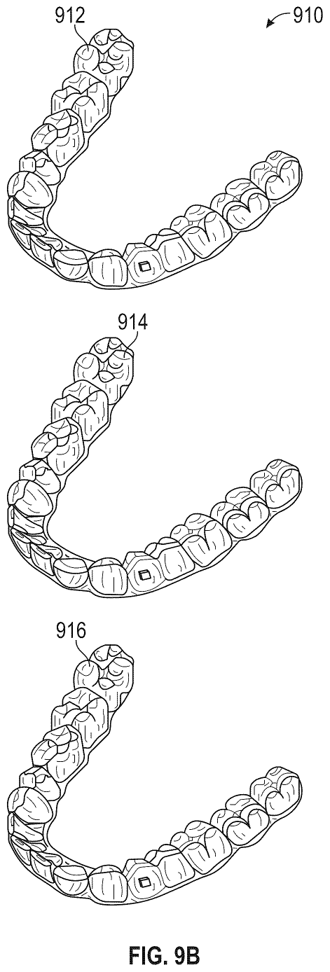

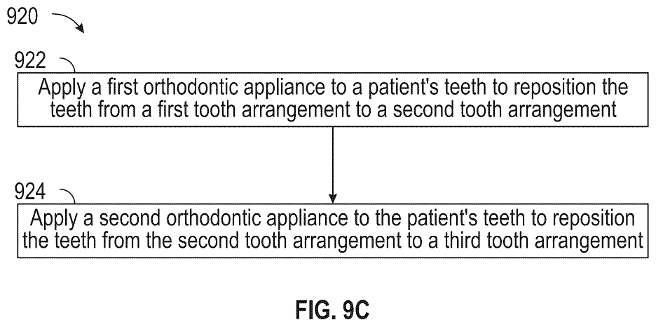

FIG. 9A illustrates a representative example of a tooth repositioning appliance 900 configured in accordance with embodiments of the present technology. The appliance 900 can be administered to a patient as part of a treatment plan in combination with any of the systems, methods, and devices described herein. The appliance 900 (also referred to herein as an “aligner”) can be worn by a patient in order to achieve an incremental repositioning of individual teeth 902 in the jaw. The appliance 900 can include a shell (e.g., a continuous polymeric shell or a segmented shell) having teeth-receiving cavities that receive and resiliently reposition the teeth. The appliance 900 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 900 can fit over all teeth present in an upper or lower jaw, or less than all of the teeth. The appliance 900 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 900 can be a generic appliance configured to receive the teeth, but not necessarily shaped to match the topography of the patient's teeth. In some cases, only certain teeth received by the appliance 900 are repositioned by the appliance 900 while other teeth can provide a base or anchor region for holding the appliance 900 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 900 in place over the teeth. In some cases, however, it may be desirable or necessary to provide individual attachments 904 or other anchoring elements on teeth 902 with corresponding receptacles 906 or apertures in the appliance 900 so that the appliance 900 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 9B illustrates a tooth repositioning system 910 including a plurality of appliances 912, 914, 916, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 910 can include a first appliance 912 corresponding to an initial tooth arrangement, one or more intermediate appliances 914 corresponding to one or more intermediate arrangements, and a final appliance 916 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 9C illustrates a method 920 of orthodontic treatment using a plurality of appliances, in accordance with embodiments of the present technology. The method 920 can be practiced using any of the appliances or appliance sets described herein. In block 922, a first orthodontic appliance is applied to a patient's teeth in order to reposition the teeth from a first tooth arrangement to a second tooth arrangement. In block 924, a second orthodontic appliance is applied to the patient's teeth in order to reposition the teeth from the second tooth arrangement to a third tooth arrangement. The method 920 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

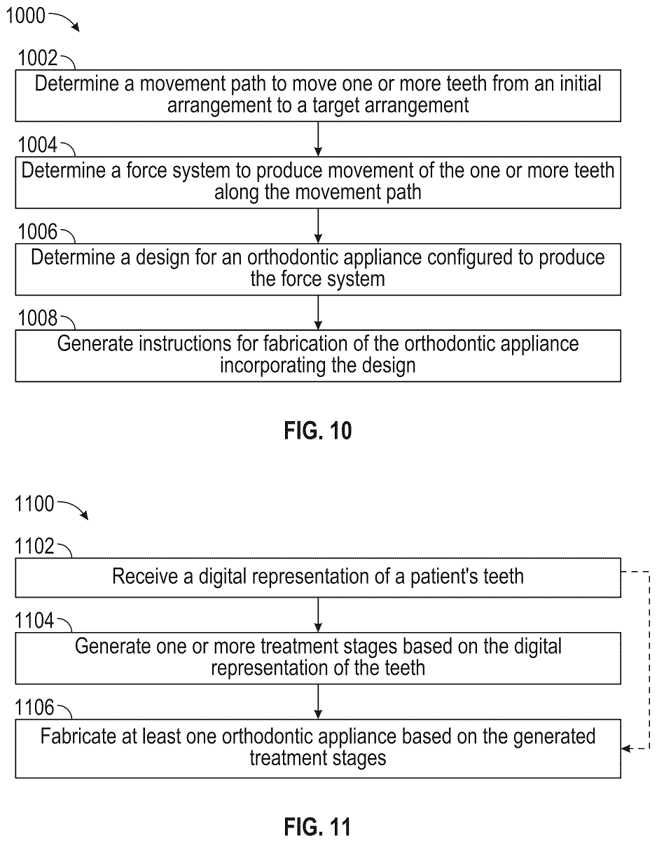

FIG. 10 illustrates a method 1000 for designing an orthodontic appliance, in accordance with embodiments of the present technology. The method 1000 can be applied to any embodiment of the orthodontic appliances described herein. Some or all of the steps of the method 1000 can be performed by any suitable data processing system or device, e.g., one or more processors configured with suitable instructions.

In block 1002, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1004, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1004 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1006, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1008, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1000 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1000 may be performed with any suitable fabrication system or device, such as the embodiments described herein. Some of the steps may be optional, e.g., the process of block 1004 can be omitted, such that the orthodontic appliance is designed based on the desired tooth movements and/or determined tooth movement path, rather than based on a force system. Moreover, the order of the steps can be varied as desired.

FIG. 11 illustrates a method 1100 for digitally planning an orthodontic treatment and/or design or fabrication of an appliance, in accordance with embodiments. The method 1100 can be applied to any of the treatment procedures described herein and can be performed by any suitable data processing system.

In block 1102 a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1104, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1106, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 11, design and/or fabrication of an orthodontic appliance, and perhaps a particular orthodontic treatment, may include use of a representation of the patient's teeth (e.g., including receiving a digital representation of the patient's teeth (block 1102)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The following examples are included to further describe some aspects of the present technology, and should not be used to limit the scope of the technology.

Example 1. A computer-implemented method for identifying teeth in a patient image, the computer-implemented method comprising, by one or more processors:
accessing a two-dimensional (2D) image comprising a depiction of a patient's teeth, wherein a plurality of the depicted patient's teeth are annotated with tooth identifiers according to a first tooth identification scheme for the patient's teeth;
accessing a three-dimensional (3D) model of the patient's teeth;
projecting a first projection of the 3D model onto the 2D image, based on the first tooth identification scheme;
comparing the first projection to the 2D image to determine a probability parameter for each of one or more teeth in the 2D image, wherein the probability parameter indicates a likelihood that a tooth identifier for the corresponding tooth in the 2D image is correct; and
determining, based on the probability parameters for the one or more teeth, a second tooth identification scheme for the patient's teeth in the 2D image, wherein the second tooth identification scheme assigns a different tooth identifier to at least one of the patient's teeth depicted in the 2D image.

Example 2. The computer-implemented method of Example 1, wherein the 2D image comprises a tooth segmentation mask, and wherein the tooth segmentation mask is used to determine the first tooth identification scheme.

Example 3. The computer-implemented method of Example 1 or 2, wherein the comparison comprises comparing the tooth segmentation mask to the first projection.

Example 4. The computer-implemented method of any one of Examples 1 to 3, further comprising registering the 3D model to the 2D image, wherein the registering comprises iteratively projecting the 3D model onto the 2D image and adjusting virtual camera parameters, and wherein the first projection comprises a projection resulting from the registering.

Example 5. The computer-implemented method of Example 4, wherein the registration is based on the first tooth identification scheme and a model tooth identification scheme for the 3D model.

Example 6. The computer-implemented method of Example 4 or 5, further comprising determining a registration score for the registration, wherein the probability parameters comprise or are based on the registration score.

Example 7. The computer-implemented method of Example 6, wherein the registration score is based on a degree of similarity between the first projection and the 2D image.

Example 8. The computer-implemented method of any one of Examples 1 to 7, wherein the comparison comprises:
determining a first tooth contour shape for a first tooth in the 2D image,
determining one or more second tooth contour shapes for one or more second teeth in the first projection, and
comparing the first tooth contour shape to the one or more second tooth contour shapes.

Example 9. The computer-implemented method of Example 8, wherein comparing the first tooth contour shape to the one or more second tooth contour shapes comprises:
determining a mean intersection over union (mIoU) between the first tooth contour shape and the one or more second tooth contour shapes, and
determining whether the mIoU is below a threshold mIoU.

Example 10. The computer-implemented method of Example 8 or 9, wherein the first tooth contour shape and the one or more second tooth contour shapes are compared based on one or more of the following shape features: tooth size, contour edge length, contour width, contour height, mean distance between the contour edge points and a centroid of the contour, standard deviation of distances between contour edge points and the centroid of the contour, concavity metric, or convexity metric.

Example 11. The computer-implemented method of any one of Examples 8 to 10, wherein the probability parameter for the first tooth is determined based on the comparison between the first tooth contour shape and the one or more second tooth contour shapes.

Example 12. The computer-implemented method of any one of Examples 1 to 11, wherein the comparison comprises:
determining a first tooth location for a first tooth in the 2D image,
determining one or more second tooth locations for one or more second teeth in the first projection, and
comparing the first tooth location to the one or more second tooth locations.

Example 13. The computer-implemented method of Example 12, wherein the first tooth location and the one or more second tooth locations are measured with respect to a reference location.

Example 14. The computer-implemented method of Example 12 or 13, wherein the probability parameter for the first tooth is determined based on the comparison between the first tooth location and the one or more second tooth locations.

Example 15. The computer-implemented method of any one of Examples 1 to 14, wherein the probability parameters are determined for each tooth of the patient's teeth in the 2D image.

Example 16. The computer-implemented method of any one of Examples 1 to 14, wherein the probability parameters are determined for only a subset of the patient's teeth in the 2D image.

Example 17. The computer-implemented method of any one of Examples 1 to 16, further comprising:
determining whether the first tooth identification scheme is likely incorrect based on the probability parameters for the one or more teeth, and
in response to a determination that the first tooth identification scheme is likely incorrect, modifying the first tooth identification scheme by changing a tooth identifier for one or more teeth of the first tooth identification scheme to produce a modified tooth identification scheme.

Example 18. The computer-implemented method of Example 17, wherein the changing comprises offsetting the first tooth identification scheme to the left or to the right by one or more teeth.

Example 19. The computer-implemented method of any one of Examples 1 to 18, further comprising:
determining whether the first tooth identification scheme is likely incorrect based on the probability parameters for the one or more teeth, and
in response to a determination that the first tooth identification scheme is likely incorrect:
   (a) producing a modified tooth identification scheme,
   (b) performing an additional projection of the 3D model onto the 2D image based on the modified tooth identification scheme,
   (c) determining additional probability parameters for the one or more teeth of the patient's teeth in the 2D image based on the additional projection, and
   repeating processes (a) through (c) until one or more stopping criteria are achieved.

Example 20. The computer-implemented method of Example 19, wherein the one or more stopping criteria comprise the additional probability parameters being substantially the same as the additional probability parameters of a previous iteration of processes (a) through (c).

Example 21. The computer-implemented method of any one of Examples 1 to 20, wherein the second tooth identification scheme is determined using an optimization algorithm.

Example 22. The computer-implemented method of Example 21, wherein the optimization algorithm is configured to identify a tooth identification scheme with a maximum posterior probability based on the comparison of the first projection and the 2D image.

Example 23. The computer-implemented method of any one of Examples 1 to 22, wherein determining the second tooth identification scheme comprises selecting a tooth identifier for each tooth of the one or more teeth based on the probability parameters that maximizes a likelihood of the second tooth identification scheme being correct.

Example 24. The computer-implemented method of any one of Examples 1 to 23, further comprising accessing a second 2D image comprising a depiction of the patient's teeth, wherein the second tooth identification scheme is determined based on the second 2D image.

Example 25. The computer-implemented method of Example 24, wherein the 2D image and the second 2D image are different image frames of a video.

Example 26. The computer-implemented method of Example 24 or 25, wherein the 2D image and the second 2D image depict the patient's teeth from different views.

Example 27. The computer-implemented method of any one of Examples 24 to 26, wherein the second 2D image has a third identification scheme, and wherein the method further comprises comparing the first and third identification schemes to each other.

Example 28. The computer-implemented method of Example 27, further comprising determining a discrepancy between the first and third identification schemes, and wherein the second identification scheme is configured to resolve the discrepancy.

Example 29. The computer-implemented method of any one of Examples 1 to 28, wherein the 2D image comprises a photograph or a frame of a video.

Example 30. The computer-implemented method of any one of Examples 1 to 29, wherein the 2D image is obtained from an imaging device that is remote from the one or more processors.

Example 31. The computer-implemented method of Example 30, wherein the imaging device comprises a camera that is part of or is operably coupled to a mobile device.

Example 32. The computer-implemented method of Example 31, wherein the 2D image is obtained during a dental treatment plan for the patient's teeth.

Example 33. The computer-implemented method of Example 32, further comprising evaluating progress of the patient's teeth relative to the dental treatment plan, based on the 2D image and the second tooth identification scheme.

Example 34. The computer-implemented method of any one of Examples 1 to 33, further comprising outputting a representation of the second tooth identification scheme on a display device.

Example 35. A system for identifying teeth in a patient image, the system comprising:
one or more processors; and
a memory operably coupled to the one or more processors and storing instructions that, when executed by the one or more processors, cause the system to perform operations comprising:
   accessing a two-dimensional (2D) image comprising a depiction of a patient's teeth, wherein a plurality of the depicted teeth are annotated with tooth identifiers according to a first tooth identification scheme for the patient's teeth;
   accessing a three-dimensional (3D) model of the patient's teeth;
   projecting a first projection of the 3D model onto the 2D image, based on the first tooth identification scheme;
   comparing the first projection to the 2D image to determine a probability parameter for each of one or more teeth in the 2D image, wherein the probability parameter indicates a likelihood that a tooth identifier for the corresponding in the 2D image is correct; and
   determining, based on the probability parameters for the one or more teeth, a second tooth identification scheme for the patient's teeth in the 2D image, wherein the second tooth identification scheme assigns a different tooth identifier to at least one of the patient's teeth depicted in the 2D image.

Example 36. The system of Example 35, wherein the 2D image comprises a tooth segmentation mask, and wherein the tooth segmentation mask is used to determine the first tooth identification scheme.

Example 37. The system of Example 36, wherein the comparison comprises comparing the tooth segmentation mask to the first projection.

Example 38. The system of any one of Examples 35 to 37, wherein the operations further comprise registering the 3D model to the 2D image, wherein the registering comprises iteratively projecting the 3D model onto the 2D image and adjusting virtual camera parameters, and wherein the first projection comprises a projection resulting from the registering.

Example 39. The system of Example 38, wherein the registration is based on the first tooth identification scheme and a model tooth identification scheme for the 3D model.

Example 40. The system of Example 38 or 39, wherein the operations further comprise determining a registration score for the registration, wherein the probability parameters comprise or are based on the registration score.

Example 41. The system of Example 40, wherein the registration score corresponds to a degree of similarity between the first projection and the 2D image.

Example 42. The system of any one of Examples 35 to 41, wherein the comparison comprises:
determining a first tooth contour shape for a first tooth in the 2D image,
determining one or more second tooth contour shapes for one or more second teeth in the first projection, and
comparing the first tooth contour shape to the one or more second tooth contour shapes.

Example 43. The system of Example 42, wherein comparing the first tooth contour shape to the one or more second tooth contour shapes comprises:
determining a mean intersection over union (mIoU) between the first tooth contour shape and the one or more second tooth contour shapes, and
determining whether the mIoU is below a threshold mIoU.

Example 44. The system of Example 42 or 43, wherein the first tooth contour shape and the one or more second tooth contour shapes are compared based on one or more of the following shape features: tooth size, contour edge length, contour width, contour height, mean distance between the contour edge points and a centroid of the contour, standard deviation of distances between contour edge points and the centroid of the contour, concavity metric, or convexity metric.

Example 45. The system of any one of Examples 42 to 44, wherein the probability parameter for the first tooth is determined based on the comparison between the first tooth contour shape and the one or more second tooth contour shapes.

Example 46. The system of any one of Examples 35 to 45, wherein the comparison comprises:
determining a first tooth location for a first tooth in the 2D image,
determining one or more second tooth locations for one or more second teeth in the first projection, and
comparing the first tooth location to the one or more second tooth locations.

Example 47. The system of Example 46, wherein the first tooth location and the one or more second tooth locations are measured with respect to a reference location.

Example 48. The system of Example 46 or 47, wherein the probability parameter for the first tooth is determined based on the comparison between the first tooth location and the one or more second tooth locations.

Example 49. The system of any one of Examples 35 to 48, wherein the probability parameters are determined for each tooth of the patient's teeth in the 2D image.

Example 50. The system of any one of Examples 35 to 48, wherein the probability parameters are determined for only a subset of the patient's teeth in the 2D image.

Example 51. The system of any one of Examples 35 to 50, wherein the operations further comprise:
determining whether the first tooth identification scheme is likely incorrect based on the probability parameters for the one or more teeth, and
in response to a determination that the first tooth identification scheme is likely incorrect, modifying the first tooth identification scheme by changing the tooth identifier for one or more teeth of the first tooth identification scheme to produce a modified tooth identification scheme.

Example 52. The system of Example 51, wherein the changing comprises offsetting the first tooth identification scheme to the left or to the right by one or more teeth.

Example 53. The system of Example 35 to 52, wherein the operations further comprise:
determining whether the first tooth identification scheme is likely incorrect based on the probability parameters for the one or more teeth, and
in response to a determination that the first tooth identification scheme is likely incorrect:
   (a) producing a modified tooth identification scheme,
   (b) performing an additional projection of the 3D model onto the 2D image based on the modified tooth identification scheme,
   (c) determining additional probability parameters for the one or more teeth of the patient's teeth in the 2D image based on the additional projection, and
   repeating processes (a) through (c) until one or more stopping criteria are achieved.

Example 54. The system of Example 53, wherein the one or more stopping criteria comprise the additional probability parameters being substantially the same as the additional probability parameters of a previous iteration of processes (a) through (c).

Example 55. The system of any one of Examples 35 to 54, wherein the second tooth identification scheme is determined using an optimization algorithm.

Example 56. The system of Example 55, wherein the optimization algorithm is configured to identify a tooth identification scheme with a maximum posterior probability based on the comparison of the first projection and the 2D image.

Example 57. The system of any one of Examples 35 to 56, wherein determining the second tooth identification scheme comprises selecting a tooth identifier for each tooth of the one or more teeth based on the probability parameters that maximizes a likelihood of the second tooth identification scheme being correct.

Example 58. The system of any one of Examples 35 to 57, wherein the operations further comprise accessing a second 2D image comprising a depiction of the patient's teeth, wherein the second tooth identification scheme is determined based on the second 2D image.

Example 59. The system of Example 58, wherein the 2D image and the second 2D image are different image frames of a video.

Example 60. The system of Example 58 or 59, wherein the 2D image and the second 2D image depict the patient's teeth from different views.

Example 61. The system of any one of Examples 58 to 60, wherein the second 2D image has a third identification scheme, and wherein the operations further comprise comparing the first and third identification schemes to each other.

Example 62. The system of Example 61, wherein the operations further comprise determining a discrepancy between the first and third identification schemes, and wherein the second identification scheme is configured to resolve the discrepancy.

Example 63. The system of any one of Examples 35 to 62, wherein the 2D image comprises a photograph or a frame of a video.

Example 64. The system of any one of Examples 35 to 63, wherein the 2D image is obtained from an imaging device that is remote from the system.

Example 65. The system of Example 64, wherein the imaging device comprises a camera that is part of or is operably coupled to a mobile device.

Example 66. The system of Example 65, wherein the 2D image is obtained during a dental treatment plan for the patient's teeth.

Example 67. The system of Example 66, wherein the operations further comprise evaluating progress of the patient's teeth relative to the dental treatment plan, based on the 2D image and the second tooth identification scheme.

Example 68. The system of any one of Examples 35 to 67, wherein the operations further comprise outputting a representation of the second tooth identification scheme on a display device.

Example 69. A computer-implemented method for identifying teeth in a patient image, the computer-implemented method comprising, by one or more processors:
accessing a two-dimensional (2D) image comprising a depiction of a patient's teeth;
accessing a three-dimensional (3D) model of the patient's teeth;
projecting a first projection of the 3D model onto the 2D image, wherein the first projection determines first tooth shapes for the patient's teeth;
determining second tooth shapes for the patient's teeth depicted in the 2D image;
comparing one or more of the first tooth shapes of the first projection to one or more corresponding second tooth shapes of the 2D image to determine a probability parameter for each of one or more teeth in the 2D image, wherein the probability parameter indicates a likelihood that a tooth identifier for the corresponding tooth in the 2D image is correct; and
determining, based on the probability parameters for the one or more teeth, a tooth identification scheme for the patient's teeth in the 2D image.

Example 70. The computer-implemented method of Example 69, wherein the first projection is based on matching at least some of the first tooth shapes with at least some of the second tooth shapes.

Example 71. The computer-implemented method of Example 69 or 70, wherein the first projection is based on comparing the first tooth shapes and the second tooth shapes based on one or more of the following shape features: tooth size, contour edge length, contour width, contour height, mean distance between the contour edge points and a centroid of the contour, standard deviation of distances between contour edge points and the centroid of the contour, concavity metric, or convexity metric.

Example 72. The computer-implemented method of any one of Examples 69 to 71, wherein the 2D image is associated with an initial tooth identification scheme.

Example 73. The computer-implemented method of Example 72, further comprising determining that a confidence level of the initial tooth identification scheme is below a pre-determined threshold for use in projecting the 3D model onto the 2D image.

Example 74. The computer-implemented method of Example 73, wherein the confidence level of the initial tooth identification scheme is based on an image quality of the 2D image.

Example 75. The computer-implemented method of Example 74, wherein the 2D image comprises one or more of the following quality issues: low lighting, bright lighting, glare, reflections, dark spots on one or more teeth, short crowns, one or more obscured teeth, or one or more indistinguishable tooth shapes.

Example 76. The computer-implemented method of any one of Examples 72 to 75, wherein the first projection is also based on the initial tooth identification scheme.

Example 77. The computer-implemented method of Example 76, wherein different weights are used for the first tooth shapes and the initial tooth identification scheme during the projecting of the first projection.

Example 78. The computer-implemented method of any one of Examples 69 to 77, further comprising:
determining whether the tooth identification scheme is likely incorrect based on the probability parameters, and
in response to a determination that the tooth identification scheme is likely incorrect, modifying the tooth identification scheme by changing the tooth identifier for one or more teeth of the tooth identification scheme to produce a modified tooth identification scheme.

Example 79. The computer-implemented method of any one of Examples 69 to 78, further comprising:
determining whether the tooth identification scheme is likely incorrect based on the probability parameters, and
in response to a determination that the tooth identification scheme is likely incorrect:
   (a) producing a modified tooth identification scheme,
   (b) performing an additional projection of the 3D model onto the 2D image based on the modified tooth identification scheme,
   (c) determining additional probability parameters for the one or more teeth of the patient's teeth in the 2D image based on the additional projection, and
   repeating processes (a) through (c) until one or more stopping criteria are achieved.

Example 80. The computer-implemented method of Example 79, wherein the one or more stopping criteria comprise the additional probability parameters being substantially the same as the additional probability parameters of a previous iteration of processes (a) through (c).

Example 81. The computer-implemented method of any one of Examples 69 to 80, wherein the comparison comprises:
determining a first tooth contour shape for a first tooth in the 2D image,
determining one or more second tooth contour shapes for one or more second teeth in the first projection, and
comparing the first tooth contour shape to the one or more second tooth contour shapes.

Example 82. The computer-implemented method of Example 81, wherein comparing the first tooth contour shape to the one or more second tooth contour shapes comprises:
determining a mean intersection over union (mIoU) between the first tooth contour shape and the one or more second tooth contour shapes, and
determining whether the mIoU is below a threshold mIoU.

Example 83. The computer-implemented method of any one of Examples 69 to 82, wherein the comparison comprises:
determining a first tooth location for a first tooth in the 2D image,
determining one or more second tooth locations for one or more second teeth in the first projection, and
comparing the first tooth location to the one or more second tooth locations.

Example 84. The computer-implemented method of any one of Examples 69 to 83, wherein the tooth identification scheme is determined using an optimization algorithm.

Example 85. The computer-implemented method of any one of Examples 69 to 84, wherein determining the tooth identification scheme comprises selecting a tooth identifier for each tooth of the one or more teeth based on the probability parameters that maximizes a likelihood of the tooth identification scheme being correct.

Example 86. The computer-implemented method of any one of Examples 69 to 85, wherein the 2D image comprises a photograph or a frame of a video.

Example 87. The computer-implemented method of any one of Examples 69 to 86, wherein the 2D image is obtained from an imaging device that is remote from the one or more processors.

Example 88. The computer-implemented method of any one of Examples 69 to 87, further comprising outputting a representation of the tooth identification scheme on a display device.

Example 89. A system for identifying teeth in a patient image, the system comprising:
one or more processors; and
a memory operably coupled to the one or more processors and storing instructions that, when executed by the one or more processors, cause the system to perform operations comprising:
   accessing a two-dimensional (2D) image comprising a depiction of a patient's teeth;
   accessing a three-dimensional (3D) model of the patient's teeth;
   projecting a first projection of the 3D model onto the 2D image, wherein the first projection determines first tooth shapes for the patient's teeth;
   determining second tooth shapes for the patient's teeth depicted in the 2D image;
   comparing one or more of the first tooth shapes of the first projection to one or more corresponding tooth shapes of the 2D image to determine a probability parameter for each of one or more teeth in the 2D image, wherein the probability parameter indicates a likelihood that a tooth identifier for the corresponding tooth in the 2D image is correct; and
   determining, based on the probability parameters for the one or more teeth, a tooth identification scheme for the patient's teeth in the 2D image.

Example 90. The system of Example 89, wherein the first projection is based on matching at least some of the first tooth shapes with at least some of the second tooth shapes.

Example 91. The system of Example 89 or 90, wherein the first projection is based on comparing the first tooth shapes and the second tooth shapes based on one or more of the following shape features: tooth size, contour edge length, contour width, contour height, mean distance between the contour edge points and a centroid of the contour, standard deviation of distances between contour edge points and the centroid of the contour, concavity metric, or convexity metric.

Example 92. The system of any one of Examples 89 to 91, wherein the 2D image is associated with an initial tooth identification scheme.

Example 93. The system of Example 92, wherein the operations further comprise determining that a confidence level of the initial tooth identification scheme is below a pre-determined threshold for use in projecting the 3D model onto the 2D image.

Example 94. The system of Example 93, wherein the confidence level of the initial tooth identification scheme is based on an image quality of the 2D image.

Example 95. The system of Example 94, wherein the 2D image comprises one or more of the following quality issues: low lighting, bright lighting, glare, reflections, dark spots on one or more teeth, short crowns, one or more obscured teeth, or one or more indistinguishable tooth shapes.

Example 96. The system of any one of Examples 92 to 95, wherein the first projection is also based on the initial tooth identification scheme.

Example 97. The system of Example 96, wherein different weights are used for the first tooth shapes and the initial tooth identification scheme during the projecting of the first projection.

Example 98. The system of any one of Examples 89 to 97, wherein the operations further comprise:
determining whether the tooth identification scheme is likely incorrect based on the probability parameters, and
in response to a determination that the tooth identification scheme is likely incorrect, modifying the tooth identification scheme by reidentifying one or more teeth of the tooth identification scheme to produce a modified tooth identification scheme.

Example 99. The system of any one of Examples 89 to 98, wherein the operations further comprise:
determining whether the tooth identification scheme is likely incorrect based on the probability parameters, and
in response to a determination that the tooth identification scheme is likely incorrect:
   (a) producing a modified tooth identification scheme,
   (b) performing an additional projection of the 3D model onto the 2D image based on the modified tooth identification scheme,
   (c) determining additional probability parameters for the one or more teeth of the patient's teeth in the 2D image based on the additional projection, and
   repeating processes (a) through (c) until one or more stopping criteria are achieved.

Example 100. The system of Example 99, wherein the one or more stopping criteria comprise the additional probability parameters being substantially the same as the additional probability parameters of a previous iteration of processes (a) through (c).

Example 101. The system of any one of Examples 89 to 100, wherein the comparison comprises:
determining a first tooth contour shape for a first tooth in the 2D image,
determining one or more second tooth contour shapes for one or more second teeth in the first projection, and
comparing the first tooth contour shape to the one or more second tooth contour shapes.

Example 102. The system of Example 101, wherein comparing the first tooth contour shape to the one or more second tooth contour shapes comprises:
determining a mean intersection over union (mIoU) between the first tooth contour shape and the one or more second tooth contour shapes, and
determining whether the mIoU is below a threshold mIoU.

Example 103. The system of any one of Examples 89 to 102, wherein the comparison comprises:
determining a first tooth location for a first tooth in the 2D image,
determining one or more second tooth locations for one or more second teeth in the projected 3D model, and
comparing the first tooth location to the one or more second tooth locations.

Example 104. The system of any one of Examples 89 to 103, wherein the tooth identification scheme is determined using an optimization algorithm.

Example 105. The system of any one of Examples 89 to 104, wherein determining the tooth identification scheme comprises selecting a tooth identifier for each tooth of the one or more teeth based on the probability parameters that maximizes a likelihood of the tooth identification scheme being correct.

Example 106. The system of any one of Examples 89 to 105, wherein the 2D image comprises a photograph or a frame of a video.

Example 107. The system of any one of Examples 89 to 106, wherein the 2D image is obtained from an imaging device that is remote from the system.

Example 108. The system of any one of Examples 89 to 107, wherein the operations further comprise outputting a representation of the tooth identification scheme on a display device.

Example 109. A non-transitory computer-readable storage medium comprising instructions that, when executed by one or more processors of a computing system, cause the computing system to perform operations comprising the computer-implemented method of any one of Examples 1-34 or 69-88.

Example 110. A computer-implemented method for identifying teeth in a patient image, the computer-implemented method comprising, by one or more processors:
accessing a two-dimensional (2D) image comprising a depiction of a patient's teeth, wherein a plurality of the depicted patient's teeth are annotated with tooth identifiers according to a first tooth identification scheme for the patient's teeth;
transmitting, to a server computing device, the 2D image; and
receiving, from the server computing device, a second tooth identification scheme for the patient's teeth in the 2D image, wherein the second tooth identification scheme is generated by:
   accessing a three-dimensional (3D) model of the patient's teeth;
   projecting a first projection of the 3D model onto the 2D image, based on the first tooth identification scheme;
   comparing the first projection to the 2D image to determine a probability parameter for each of one or more teeth in the 2D image, wherein the probability parameter indicates a likelihood that a tooth identifier for the corresponding tooth in the 2D image is correct; and
   determining, based on the probability parameters for the one or more teeth, the second tooth identification scheme, wherein the second tooth identification scheme assigns a different tooth identifier to at least one of the patient's teeth depicted in the 2D image.

Example 111. The computer-implemented method of Example 110, wherein the 2D image comprises a tooth segmentation mask, and wherein the tooth segmentation mask is used to determine the first tooth identification scheme.

Example 112. The computer-implemented method of Example 111, wherein the comparison comprises comparing the tooth segmentation mask to the first projection.

Example 113. The computer-implemented method of any one of Examples 110 to 112, wherein generating the second tooth identification scheme further comprises registering the 3D model to the 2D image, wherein the registering comprises iteratively projecting the 3D model onto the 2D image and adjusting virtual camera parameters, and wherein the first projection comprises a projection resulting from the registering.

Example 114. The computer-implemented method of Example 113, wherein generating the second tooth identification scheme further comprises determining a registration score for the registration, wherein the probability parameters comprise or are based on the registration score.

Example 115. The computer-implemented method of any one of Examples 110 to 114, wherein the comparison comprises:
determining a first tooth contour shape for a first tooth in the 2D image,
determining one or more second tooth contour shapes for one or more second teeth in the first projection, and
comparing the first tooth contour shape to the one or more second tooth contour shapes.

Example 116. The computer-implemented method of Example 115, wherein the probability parameter for the first tooth is determined based on the comparison between the first tooth contour shape and the one or more second tooth contour shapes.

Example 117. The computer-implemented method of any one of Examples 110 to 116, wherein the probability parameters are determined for only a subset of the patient's teeth in the 2D image.

Example 118. The computer-implemented method of any one of Examples 110 to 117, wherein generating the second tooth identification scheme further comprises:
determining whether the first tooth identification scheme is likely incorrect based on the probability parameters for the one or more teeth, and
in response to a determination that the first tooth identification scheme is likely incorrect:
(a) producing a modified tooth identification scheme,
(b) performing an additional projection of the 3D model onto the 2D image based on the modified tooth identification scheme,
(c) determining additional probability parameters for the one or more teeth of the patient's teeth in the 2D image based on the additional projection, and
repeating processes (a) through (c) until one or more stopping criteria are achieved.

Example 119. The computer-implemented method of any one of Examples 110 to 118, further comprising outputting a representation of the second tooth identification scheme on a display device.

### CONCLUSION

Although many of the embodiments are described above with respect to systems, devices, and methods for tooth identification, the technology is applicable to other applications and/or other approaches, such as identification of other types of objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-11.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A computer-implemented method for identifying teeth in a patient image, the computer-implemented method comprising, by one or more processors:
accessing a two-dimensional (2D) image comprising a depiction of a patient's teeth, wherein a plurality of the depicted patient's teeth are annotated with tooth identifiers according to a first tooth identification scheme for the patient's teeth;
transmitting, to a server computing device, the 2D image; and
receiving, from the server computing device, a second tooth identification scheme for the patient's teeth in the 2D image, wherein the second tooth identification scheme is generated by:
accessing a three-dimensional (3D) model of the patient's teeth;
projecting a first projection of the 3D model onto the 2D image, based on the first tooth identification scheme;
comparing the first projection to the 2D image to determine a probability parameter for each of one or more teeth in the 2D image, wherein the probability parameter indicates a likelihood that a tooth identifier for the corresponding tooth in the 2D image is correct; and
determining, based on the probability parameters for the one or more teeth, the second tooth identification scheme, wherein the second tooth identification scheme assigns a different tooth identifier to at least one of the patient's teeth depicted in the 2D image.

2. The computer-implemented method of claim 1, wherein the 2D image comprises a tooth segmentation mask, and wherein the tooth segmentation mask is used to determine the first tooth identification scheme.

3. The computer-implemented method of claim 2, wherein the comparison comprises comparing the tooth segmentation mask to the first projection.

4. The computer-implemented method of claim 1, wherein generating the second tooth identification scheme further comprises registering the 3D model to the 2D image, wherein the registering comprises iteratively projecting the 3D model onto the 2D image and adjusting virtual camera parameters, and wherein the first projection comprises a projection resulting from the registering.

5. The computer-implemented method of claim 4, wherein generating the second tooth identification scheme further comprises determining a registration score for the registration, wherein the probability parameters comprise or are based on the registration score.

6. The computer-implemented method of claim 1, wherein the comparison comprises:
determining a first tooth contour shape for a first tooth in the 2D image,
determining one or more second tooth contour shapes for one or more second teeth in the first projection, and
comparing the first tooth contour shape to the one or more second tooth contour shapes.

7. The computer-implemented method of claim 6, wherein the probability parameter for the first tooth is determined based on the comparison between the first tooth contour shape and the one or more second tooth contour shapes.

8. The computer-implemented method of claim 1, wherein the probability parameters are determined for only a subset of the patient's teeth in the 2D image.

9. The computer-implemented method of claim 1, wherein generating the second tooth identification scheme further comprises:
determining whether the first tooth identification scheme is likely incorrect based on the probability parameters for the one or more teeth, and
in response to a determination that the first tooth identification scheme is likely incorrect:
(a) producing a modified tooth identification scheme,
(b) performing an additional projection of the 3D model onto the 2D image based on the modified tooth identification scheme,
(c) determining additional probability parameters for the one or more teeth of the patient's teeth in the 2D image based on the additional projection, and
repeating processes (a) through (c) until one or more stopping criteria are achieved.

10. The computer-implemented method of claim 1, further comprising outputting a representation of the second tooth identification scheme on a display device.

11. A system for identifying teeth in a patient image, the system comprising:
one or more processors; and
a memory operably coupled to the one or more processors and storing instructions that, when executed by the one or more processors, cause the system to perform operations comprising:
accessing a two-dimensional (2D) image comprising a depiction of a patient's teeth, wherein a plurality of the depicted teeth are annotated with tooth identifiers according to a first tooth identification scheme for the patient's teeth;
accessing a three-dimensional (3D) model of the patient's teeth;
projecting a first projection of the 3D model onto the 2D image, based on the first tooth identification scheme;
comparing the first projection to the 2D image to determine a probability parameter for each of one or more teeth in the 2D image, wherein the probability parameter indicates a likelihood that a tooth identifier for the corresponding in the 2D image is correct; and
determining, based on the probability parameters for the one or more teeth, a second tooth identification scheme for the patient's teeth in the 2D image, wherein the second tooth identification scheme assigns a different tooth identifier to at least one of the patient's teeth depicted in the 2D image.

12. The system of claim 11, wherein the 2D image comprises a tooth segmentation mask, and wherein the tooth segmentation mask is used to determine the first tooth identification scheme.

13. The system of claim 12, wherein the comparison comprises comparing the tooth segmentation mask to the first projection.

14. The system of claim 11, wherein the operations further comprise registering the 3D model to the 2D image, wherein the registering comprises iteratively projecting the 3D model onto the 2D image and adjusting virtual camera parameters, and wherein the first projection comprises a projection resulting from the registering.

15. The system of claim 11, wherein the comparison comprises:
determining a first tooth contour shape for a first tooth in the 2D image,
determining one or more second tooth contour shapes for one or more second teeth in the first projection, and
comparing the first tooth contour shape to the one or more second tooth contour shapes.

16. The system of claim 15, wherein the probability parameter for the first tooth is determined based on the comparison between the first tooth contour shape and the one or more second tooth contour shapes.

17. The system of claim 11, wherein the probability parameters are determined for only a subset of the patient's teeth in the 2D image.

18. The system of claim 11, wherein the operations further comprise:
determining whether the first tooth identification scheme is likely incorrect based on the probability parameters for the one or more teeth, and
in response to a determination that the first tooth identification scheme is likely incorrect:
(a) producing a modified tooth identification scheme,
(b) performing an additional projection of the 3D model onto the 2D image based on the modified tooth identification scheme,
(c) determining additional probability parameters for the one or more teeth of the patient's teeth in the 2D image based on the additional projection, and
repeating processes (a) through (c) until one or more stopping criteria are achieved.

19. The system of claim 11, wherein the 2D image and the second 2D image are different image frames of a video.

20. The system of claim 11, wherein the operations further comprise outputting a representation of the second tooth identification scheme on a display device.
